(19) United States
(12) Patent Application Publication
(10) Pub. No.: US 2023/0185994 A1
(43) Pub. Date: Jun. 15, 2023

(54) COMPUTATIONAL ANALYSIS OF PHYSICAL SYSTEMS

(71) Applicant: Oxford University Innovation Limited, Oxford (GB)

(72) Inventor: Yuewen JIANG, Oxford (GB)

(21) Appl. No.: 17/924,700

(22) PCT Filed: May 10, 2021
(86) PCT No.: PCT/GB2021/051117

§ 371 Date: Nov. 11, 2022

(30) Foreign Application Priority Data
May 14, 2020 (GB) 2007110.6

(51) Int. Cl. G06F 30/23; G06F 30/28

(52) U.S. Cl. CPC G06F 30/23; G06F 30/28; G06F 2111/10

(57) ABSTRACT

In order to perform computational analysis of a physical system using a mesh of discrete nodes, for some of the nodes there are derived face area vectors between algebraic volumes associated with each algebraic volume node and neighbouring volumes in the mesh from solutions of discretized differential flux equations representing fluxes between the respective algebraic volume and each neighbouring volume. An integral form of the modelling equations representing relationships between physical properties of the physical system are discretized into volume equations in respect of volumes associated with respective nodes, using the derived face area vectors for the algebraic volumes, instead of finite volumes derived geometrically. Solution of the volume equations provides information on the physical properties of the physical system.

The present invention relates to computational analysis of physical systems.

Computational analysis of physical systems is essential to basic research in a wide range of technical fields and hence to the wide-ranging practical applications that depend thereupon. Such computational analysis has become popular and has been employed for a wide range of the physical areas such as molecular dynamics, nuclear, fluid mechanics, meteorology, and oceanography, etc. Typically, the physical system that is modelled by modelling equations representing relationships between physical properties of the physical system, which are typically partial differential equation (PDE).

Generally, such computational analysis includes two key procedures, namely mesh generation and numerical discretization.

Mesh generation is a subdivision of a continuous geometric space into a mesh of discrete nodes which may be associated with geometric and topological elements. Its quality and number significantly affects the subsequent calculations.

Numerical discretization is a discretization of the modelling equations into equations associated with each node. It is highly dependent on the mesh generation for qualities such as numerical scheme, accuracy, and stability, etc.

The meshing remains a bottleneck for complicated configurations even if it has been fast developed for several decades. It is a time-consuming task to construct a suitable mesh to represent the computational domain. Moreover, it requires much manual intervention to deal with the details of geometry that is time consuming and difficult for engineers. The tetrahedron (triangulation in 2D) mesh generation method has already been well developed. But the meshing becomes challenging when boundary layer flow simulation is involved. A high aspect ratio anisotropic mesh is frequently utilized in the boundary layer because it is of great benefit to solve the boundary-layer flow. Meshing failure happens very often in this layer of a complicated configuration such as corner, sharp edge, moving structure, etc. Engineers have to repeatedly adjust the meshing parameters, such as cell size, mesh distribution, initial height, height ratio, to obtain a mesh. It takes long time and much labour. Therefore, meshing method is an important but difficult topic.

Known mesh methods will now be discussed.

At the moment, there are only three types of mesh frequently utilized in simulations, namely structured mesh, unstructured mesh, and meshfree points. In order to clarify the description, herein two words “node” and “point” are used for mesh methods and meshfree methods, respectively, but each is a point in space.

Structured and unstructured meshes utilise a geometric mesh of nodes which requires topology connection while the meshfree method abandons this constraint for a mesh of points. The word “meshfree” signifies the abandonment of this constraint, but from a mathematical perspective meshfree methods are considered herein as a special type of mesh because they do use a mesh of points.

After the development of each mesh method, the corresponding numerical methods are required to discretize the modelling equations. Each type of mesh has its own advantages and disadvantages. They are briefly discussed below.

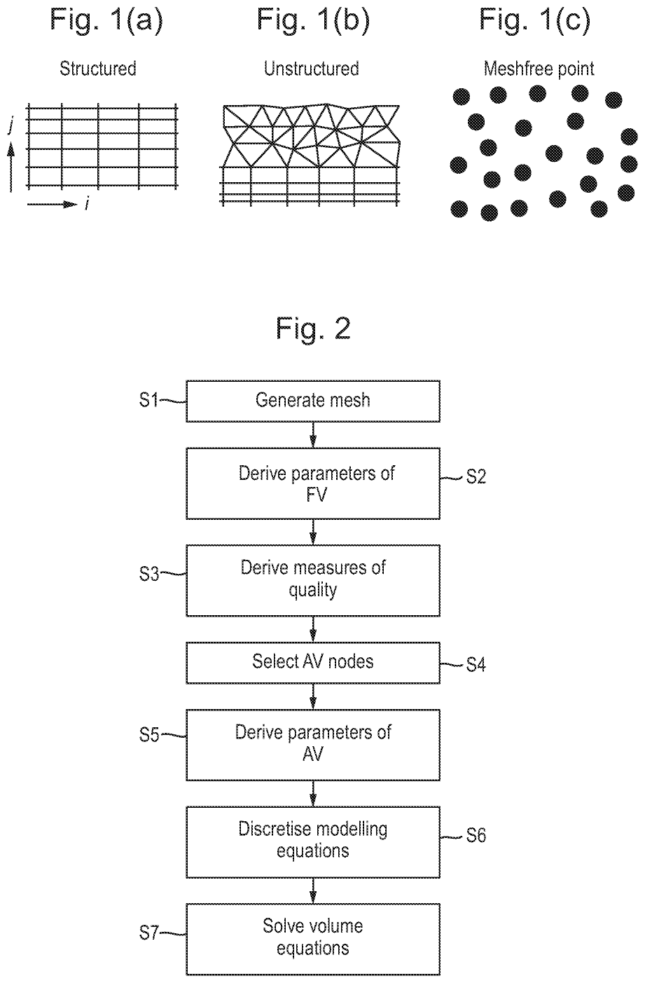

A structured mesh, for example as illustrated in FIG. 1(a), is one of the most important and popular mesh methods. Each node of structured mesh has a unique and continuous integer number set (i, j, k) (or (i, j) in 2D) to record the position information and relationship with neighbours. This strictly constrained meshing is convenient to design the numerical schemes for the discretization of partial differential equations. The basic topology of structured mesh is O-type, C-type, and H-type. Nowadays, structured mesh methods are still fast developing, including examples such as multi-block methods disclosed in Reference [1], chimera methods disclosed in Reference [2], automatic blocking methods disclosed in Reference [3].

Even though structured mesh methods are widely used, it takes significant effort to generate a high quality mesh. The reason is that the mesh topology requirement is strict. This drawback makes mesh generation of structured meshes less flexible, especially for complex geometry. This problem is reduced by unstructured meshes which are now described.

An unstructured mesh is a mesh of nodes with an orderless, non-regular topology, for example as illustrated in FIG. 1(b). This increases flexibility in mesh generation, reducing the generation time and difficulty dramatically. Accordingly, this has become the most popular mesh method. Unstructured mesh generation methods is reviewed in Reference [4] and some recent methods are discussed in References [5, 6]. A simpler and automatic meshing method for inviscid flow simulation is the Cartesian mesh. Unfortunately, this method becomes more complex when it is utilized for viscous flow simulation as discussed in Reference [7]. Another enhancement of unstructured mesh is the arbitrary topology mesh as discussed in Reference [8].

Another solution is to use structured and unstructured mesh together. One example discussed in References [9, 10] is to use a “Direct Replacement of Arbitrary Grid Overlapping by Nonstructured” grid and the corresponding flow solution methods. The structured mesh was dominated for meshing while the unstructured mesh was utilized to deal with the overlapped regions. Accordingly, different solver codes were employed for the structured mesh and unstructured mesh. Another example discussed in Reference [11] applied a hybrid structured mesh and Cartesian mesh method to study the sonic boom propagation, the two meshes being solved by different solvers.

With a structured or unstructured mesh, numerical discretization involves discretizing an integral form of the modelling equations into equations in respect of volumes associated with respective nodes of the mesh, which will be referred to herein as “volume equations” for ease of reference. The volume equations in respect of each volume represent the relationship between the size of the volume, the face area vectors between the respective volume and neighbouring volumes in the mesh, and fluxes across the face areas. The sizes and face area vectors represented in the volume equations in respect of the nodes are derived from the solutions of geometrical equations describing the geometry of the finite volumes. By solving the volume equations, information on the physical properties of the physical system is derived.

The unstructured mesh boosts the fast development of computational analysis by breaking the strict topology constraint of the structured mesh. But an unstructured mesh still needs the connection between nodes. This requirement may cause problems. For example, when two connected bodies are separating from each other, the mesh connectivity makes it difficult to avoid negative sizes (negative volumes). Accordingly, researchers developed the meshfree method which gives up the mesh connection, for example as illustrated in FIG. 1(c). This further increases the meshing flexibility, allowing meshing of extremely complicated geometries, and deals with dynamic response of the solid boundary such as the explosion, insect flight, etc.

Some examples are as follows. Reference [12] presents a stabilized meshfree method for the simulation of incompressible flow. The stabilization approach was based in the finite increment calculus procedure. Reference [13] discusses store separation, using a meshfree Euler solver which employs an entropy variables based least squares kinetic upwind scheme. Reference [14] proposes an implicit meshfree method to solve 2D Euler and Navier-Stokes equations of which spatial derivatives were approximated by a least squares method. Reference [15] proposes a multilevel method to accelerate the convergence for Radial Basis Function-generated Finite Difference meshfree discretization. Additive correction multicloud and smoothed restriction multicloud methods were presented.

Another approach is to use the hybrid meshfree/mesh-based method. For example, References [16, 17] disclose a coupled meshfree/mesh-based method for the incompressible Navier-Stokes equations. A meshfree Galerkin method was established for the meshfree zone while the finite element method was used for the mesh zone. Different shape functions were applied for the corresponding method. In order to simulate the high-Reynolds number flow, Reference [18] proposed a hybrid meshfree and finite volume method. It employed the finite volume method for boundary layer and meshfree method for the outer region.

A particular challenge is complicated configurations, as found in a wide range of technical applications, for example complex biological organ geometries, nuclear reactor simulations, and cooling system of high-pressure turbine blade, etc. This challenge makes it difficult to automate mesh generation of structured or unstructured meshes, and manual intervention is time-consuming and difficult. In practice, mesh generation represents a bottleneck for engineers applying numerical analysis to a practical situation. Meshfree methods are a possible solution for meshing complicated configurations, because they can easily generate the points for arbitrary physical domain. However, the numerical methods are challenging to solve the complex PDEs such as the Navier-Stokes (NS) equations. Thus, the accuracy, efficiency, and robustness, which are low compared to structured and unstructured meshes which are relatively accurate and robust, limit effectiveness of meshfree methods. Few studies have been found to employ the meshfree method to solve complicated configurations to date.

It would be highly desirable to tackle these problems.

According to an aspect of the present invention, there is provided a method of computational analysis of a physical system that is modelled by modelling equations representing relationships between physical properties of the physical system, the method comprising: generating a mesh of discrete nodes; in respect of at least some of the nodes referred to as algebraic volume nodes, deriving face area vectors between algebraic volumes associated with each algebraic volume node and neighbouring volumes in the mesh from solutions of discretized differential flux equations for each algebraic volume representing fluxes between the respective algebraic volume and each neighbouring volume in the mesh; discretizing an integral form of the modelling equations into volume equations in respect of volumes associated with respective nodes of the mesh, the volume equations in respect of each volume representing the relationship between the size of the volume, the face area vectors between the respective volume and neighbouring volumes in the mesh, and fluxes across the face areas, wherein the face area vectors represented in the volume equations in respect of the algebraic volume nodes are the face area vectors derived from the solutions of the discretized differential flux equations; and solving the volume equations and deriving information on the physical properties of the physical system.

Similar to a structured mesh or unstructured mesh, this method involves discretization of an integral form of the modelling equations into volume equations in respect of volumes associated with respective nodes of the mesh. The volume equations in respect of each volume represent the relationship between the size of the volume, the face area vectors between the respective volume and neighbouring volumes in the mesh, and fluxes across the face areas, but the size and face area vectors are not necessarily derived from the solutions of geometrical equations representing the geometry of the finite volumes. Instead, in respect of at least some of the volumes that are referred to herein as “algebraic volumes”, the size and face area vectors are derived using a different algebraic technique.

In particular, in respect of the algebraic volumes, the face area vectors are derived from solutions of discretized differential flux equations for each algebraic volume representing fluxes between the respective algebraic volume and each neighbouring volume in the mesh. Such discretized differential flux equations may be considered as analogous to the equations used in a meshfree method, but in contrast to a meshfree method they are not solved to derive information on the physical properties of the physical system. Instead, they are solved to provide the face area vectors. In this manner, the algebraic volumes can be derived in a manner that significantly reduces the problems associated with a structured or unstructured mesh that are described above. For example, the derivation of the algebraic volumes avoids the problems that a geometric derivation may provide volumes of low quality or negative size. This allows much greater geometric flexibility in the mesh generation which may therefore be as general, automated, efficient, and flexible as meshfree methods. This in turn greatly reduces the need for manual intervention in the mesh generation, saving time and increasing productivity for the engineer performing the computational analysis.

However, the volume equations generated in respect of each algebraic volume are of the same type as volume equations generated for a structured or unstructured mesh. Thus, the present method retains the benefits of a structured or unstructured mesh that the solution of the volume equations is robust, stable and accurate. Moreover, the numerical method has the potential to achieve a better convergence performance.

In summary, therefore, the present method provides both the geometric flexibility of meshfree methods points (without geometric connectivity) and physical accuracy of structured and unstructured mesh (with node connectivity), because meshing failure is inherently avoided for arbitrarily complicated configurations even with moving boundaries. These advantages are of particular benefit for analysis of physical systems having complicated configurations.

Advantageously, the sizes of the algebraic volumes may be identical, for example unitary. This simplifies the derivation of the face area vectors. Alternatively, the sizes of the algebraic volume may have predetermined values that are different, for example proportional to the inverse of the local node density.

In the present method, it is possible that algebraic volumes are associated with only some of the nodes. Volumes that are referred to as “finite volumes” are associated with the other nodes. Sizes and face area vectors for each volume equation are derived from the solutions of the geometrical equations. An integral form of the modelling equations are discretised into volume equations in respect of the finite volumes. The volume equations in respect of each finite volume represent the relationship between the geometrically derived size of the volume, the geometrically derived face area vectors between the respective volume and neighbouring volumes in the mesh, and fluxes across the face areas.

Thus, the finite volumes are treated in a similar manner to volumes associated with nodes in the structured and unstructured meshes described above. In this manner, the algebraic volumes and finite volumes may be used together for different nodes of the generated mesh.

The volume equations in respect of the algebraic volume nodes and the volume equations in respect of the finite volume nodes may have a unified representation. This allows the algebraic volume nodes and the volume equations to be treated in the same manner when solving the volume equations. This improves the efficiency of the computational analysis. For example, the step of solving the volume equations may use a common solver for the algebraic volume nodes and the finite volume nodes.

Compared to the existing grid and gridfree methods, the unified mesh/meshfree method is endowed by nature with both the geometric flexibility of points (without geometric connectivity) and physical accuracy of mesh (with node connectivity): the meshing failure is inherently avoided for arbitrarily complicated configurations even with moving boundaries;

In one example, selection of nodes as finite volume nodes or algebraic nodes may be performed as follows. In this example, at least one measure of quality of a finite volume associated with each node may be derived, and then nodes that are indicated by the at least one measure of quality to be of low quality may be selected as algebraic volume nodes and other nodes may be selected as finite volume nodes. Advantageously, this method of selection allows the advantages of the algebraic nodes described above to be achieved specifically for the nodes of low quality. However, selection of selection of nodes as finite volume nodes or algebraic nodes may be based on other criteria, for example based on distance from a moving object or on user input.

In this example, the at least one measure of quality may include one or more of: the size of the finite volume; a measure of aspect ratio of the finite volume; a measure of skewness of the mesh in the locality of the node; a measure of smoothness of transitions in the size of finite volumes associated with neighbouring nodes in the locality of the node; and an orthogonal quality of the finite volume.

The present method may be applied to a wide range of physical systems.

The physical system may be a fluid system and the present methods are of particular application to computational fluid dynamics (CFD). By way of non-limitative example, in this case the modelling equations may be the Navier-Stokes equations, optionally including modifications for inviscid flow. However, the present methods are not limited to a fluid system, and may be applied to other physical systems, typically being a physical system having a physical property that is conserved.

Some non-limitative examples of physical systems to which the present method may be applied include a non-Newtonian fluid system, a magnetohydrodynamics system, conjugate heat transfer and plasma system, a solid mechanics system represented by PDEs, and other advection-diffusion systems.

According to further aspects of the present invention, there are provided a computer program capable of execution by a computer apparatus and configured, on execution, to cause the computer apparatus to perform a similar method, a computer-readable storage medium storing such a computer program, and a computer apparatus arranged to perform a similar method.

To allow better understanding, embodiments of the present invention will now be described by way of non-limitative example with reference to the accompanying drawings, in which:

FIG. 1 is a set of illustrative diagrams of a) a structured mesh, b) an unstructured mesh, and c) a set of meshfree points;

FIG. 2 is a flow chart of a method of computational analysis of a physical system;

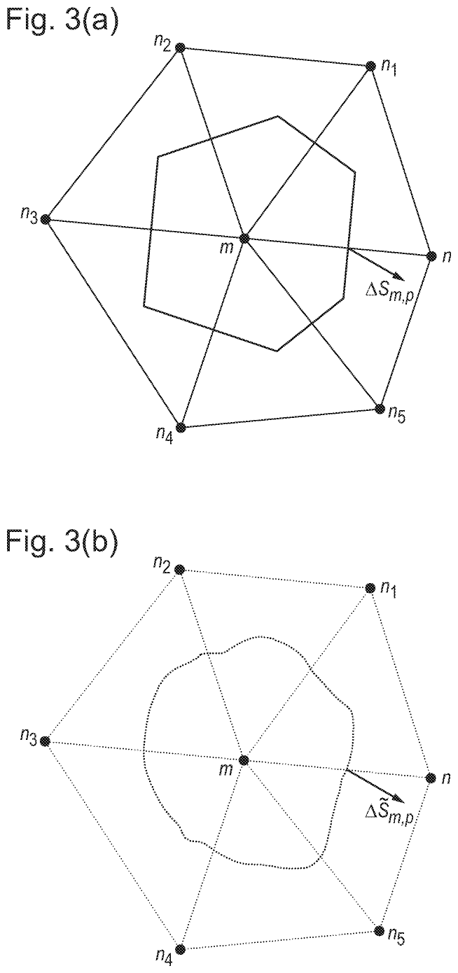

FIG. 3(a) is a 2D example of a finite volume and FIG. 3(b) is a 2D example of an algebraic volume;

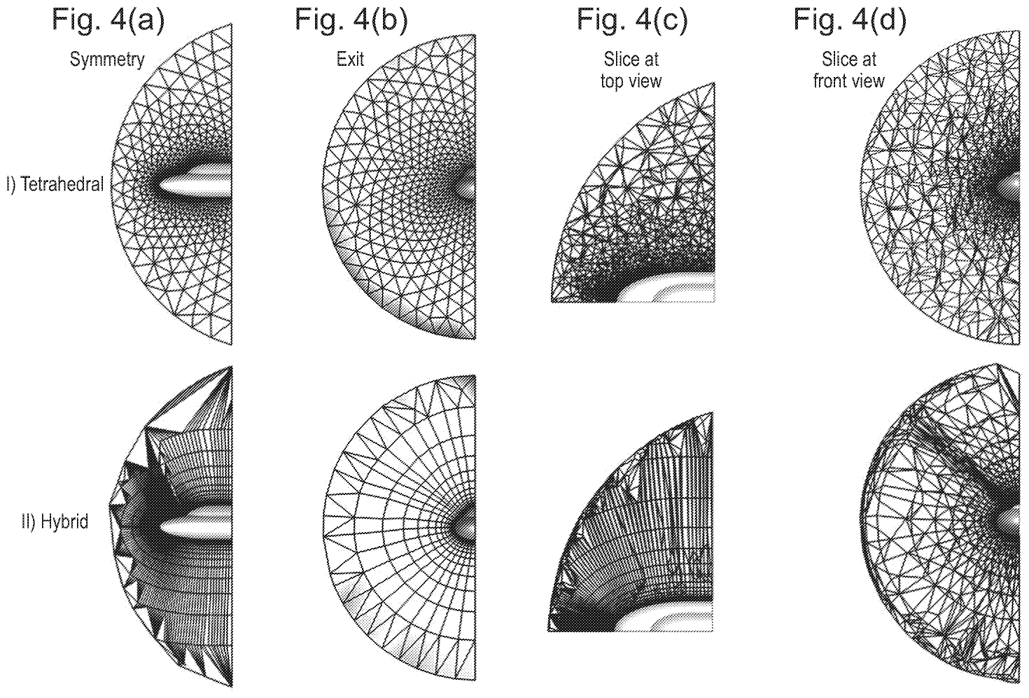

FIG. 4 is a set of views of a demonstration of mesh generation for four slices (a) to (d) and for a tetrahedral mesh (I) and a hybrid mesh (II);

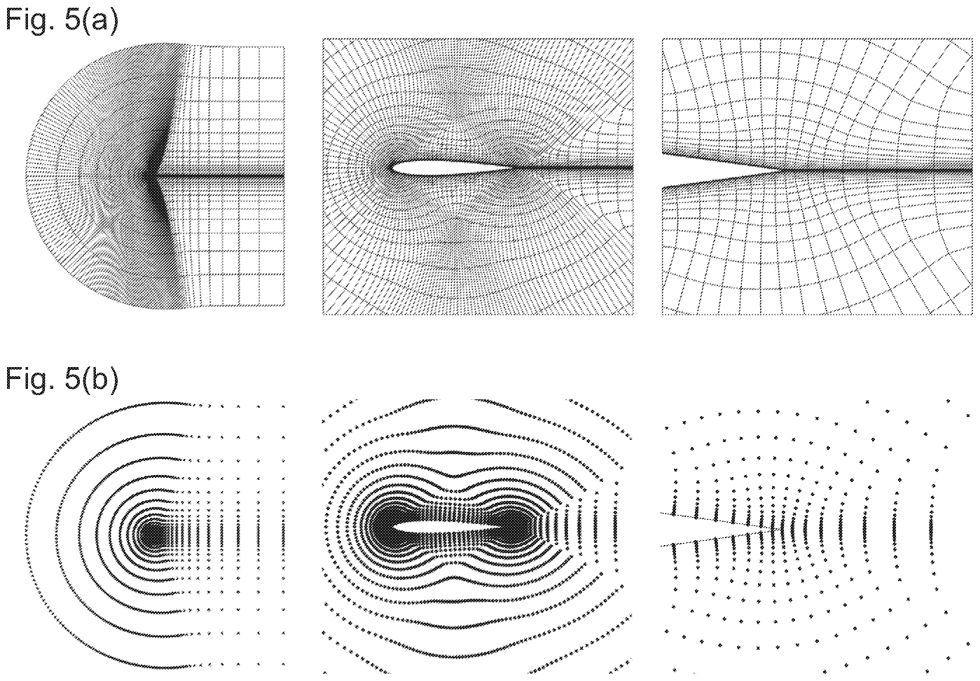

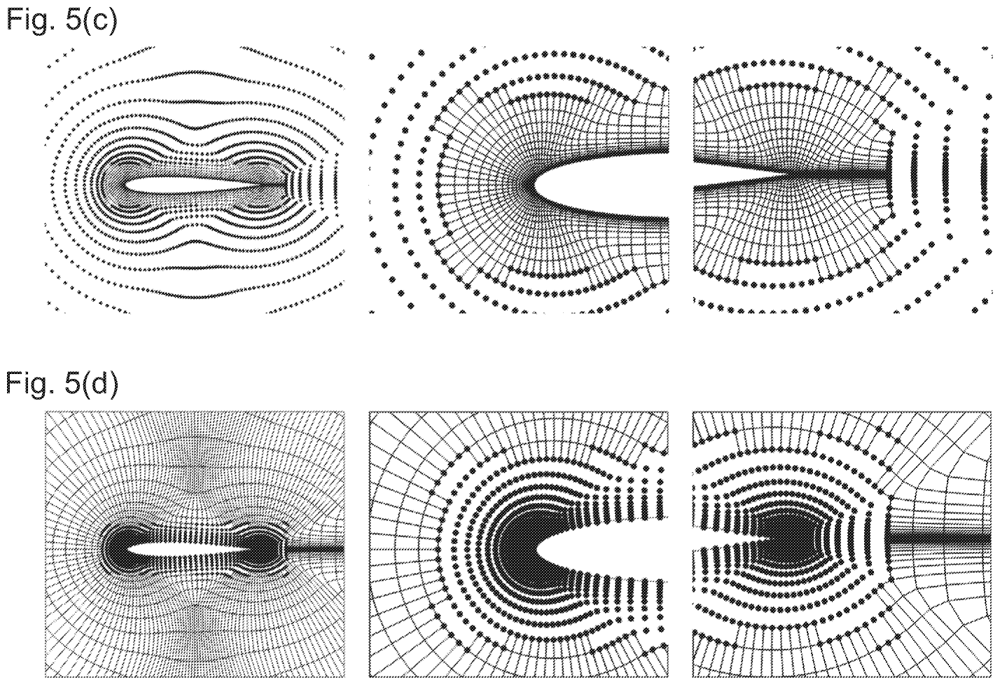

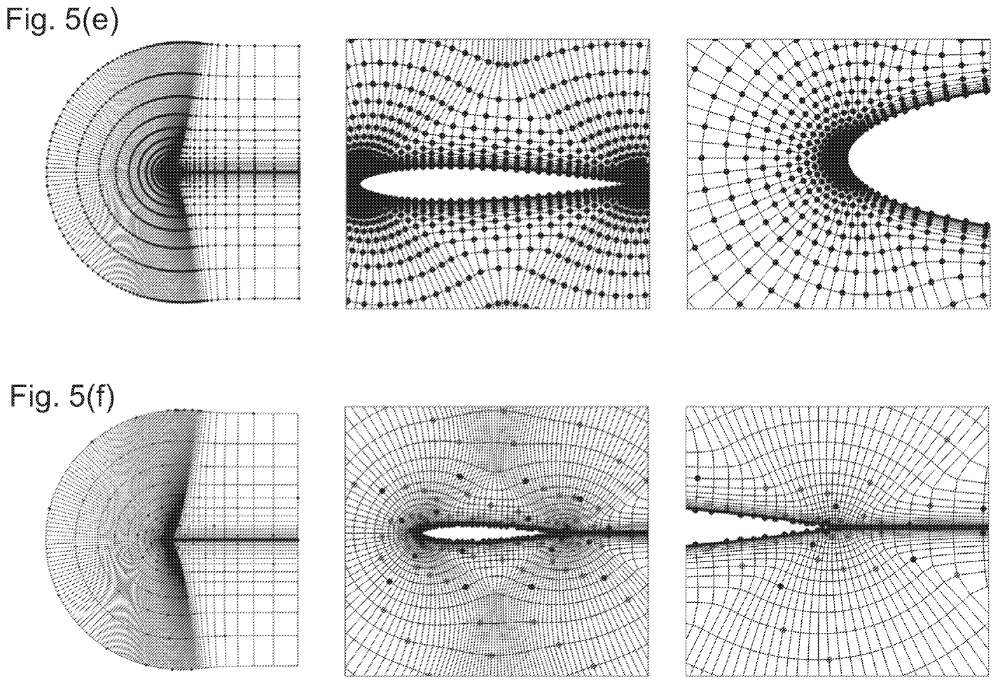

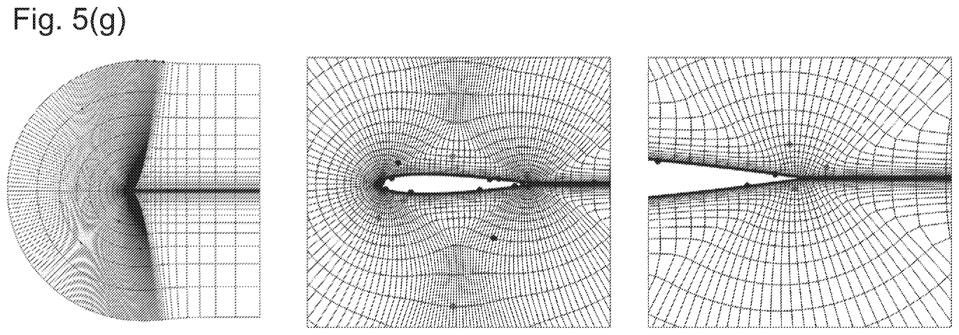

FIGS. 5(a) to 5(g) are each a set of three drawings of respective meshes generated around an example of an airfoil, FIG. 5(a) being a traditional geometric mesh, FIG. 5(b) being meshfree points, FIG. 5(c) being a zonal general mesh with an inner mesh zone and an outer point zone, FIG. 5(d) being a zonal general mesh with an inner point zone and an outer mesh zone, FIG. 5(e) being a fusion general mesh with 50% mesh nodes and 50% points, FIG. 5(f) being a fusion general mesh with 99% mesh nodes and 1% points, and FIG. 5(g) being a fusion general mesh with 99.9% mesh nodes and 0.1% points;

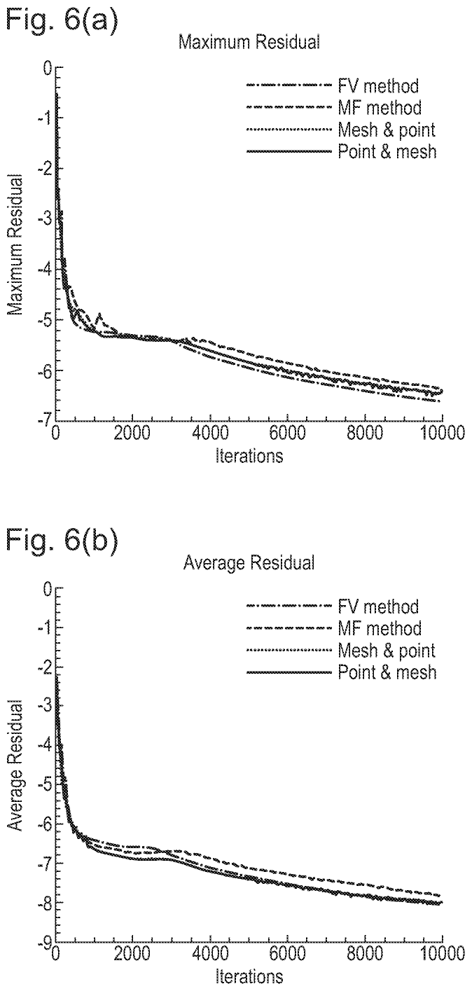

FIGS. 6(a) and 6(b) are graphs of convergence history of a maximum residual and an average residual, respectively, at Ma=0.15;

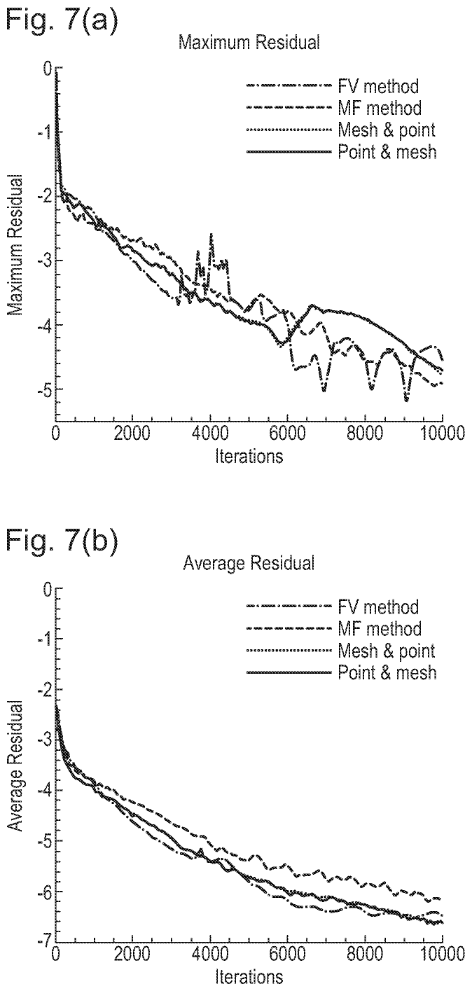

FIGS. 7(a) and 7(b) are graphs of convergence history of a maximum residual and an average residual, respectively, at Ma=0.775;

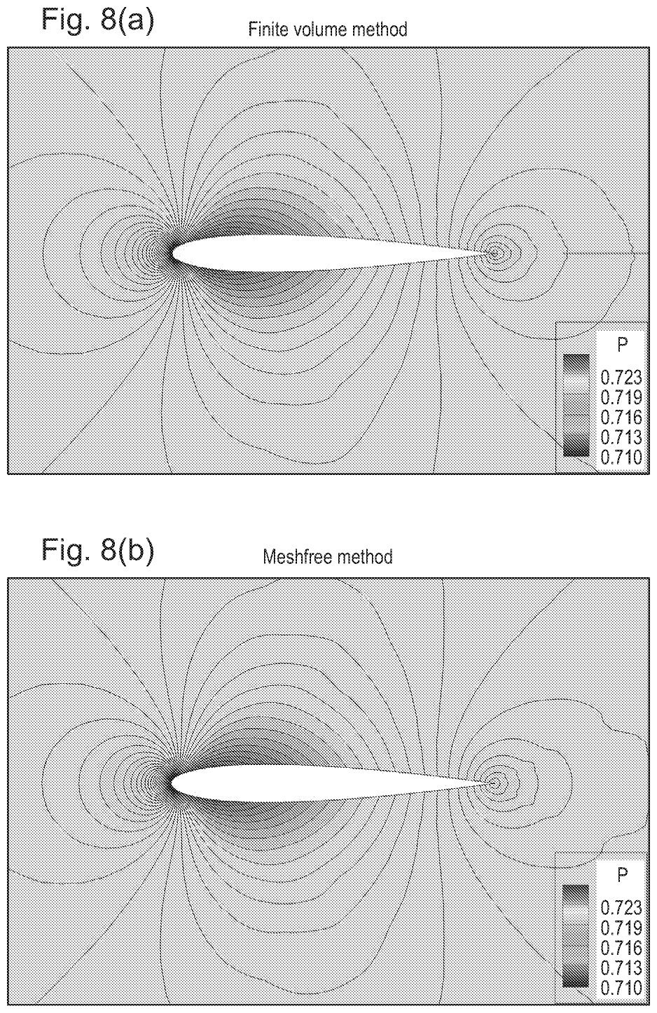

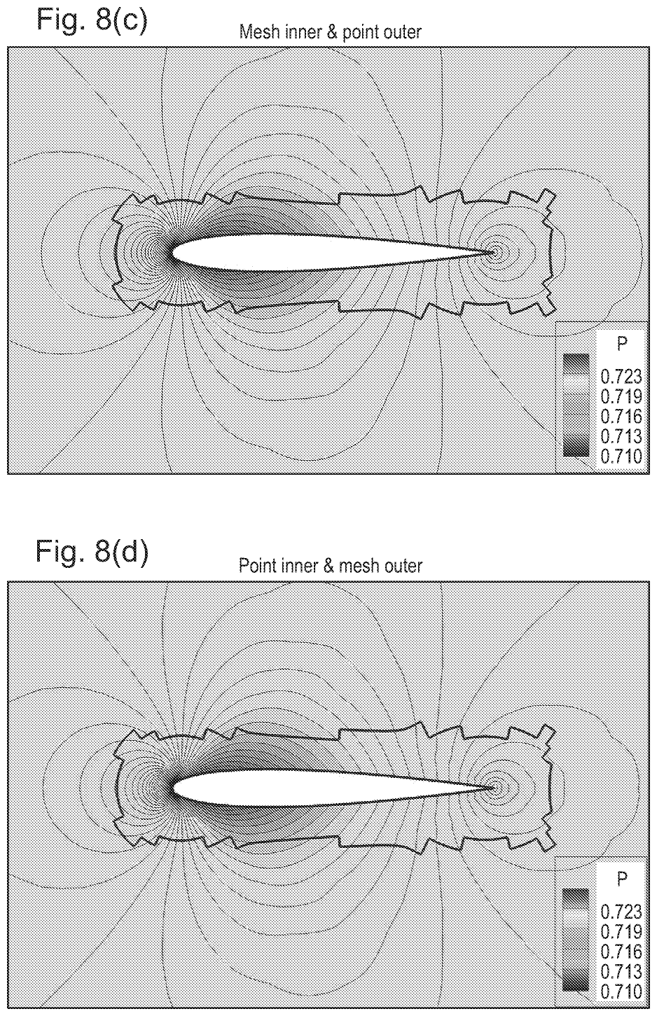

FIGS. 8(a) to 8(d) are plots of the flow field for the approaches of FIGS. 5(a) to 5(d), respectively, at Ma=0.15;

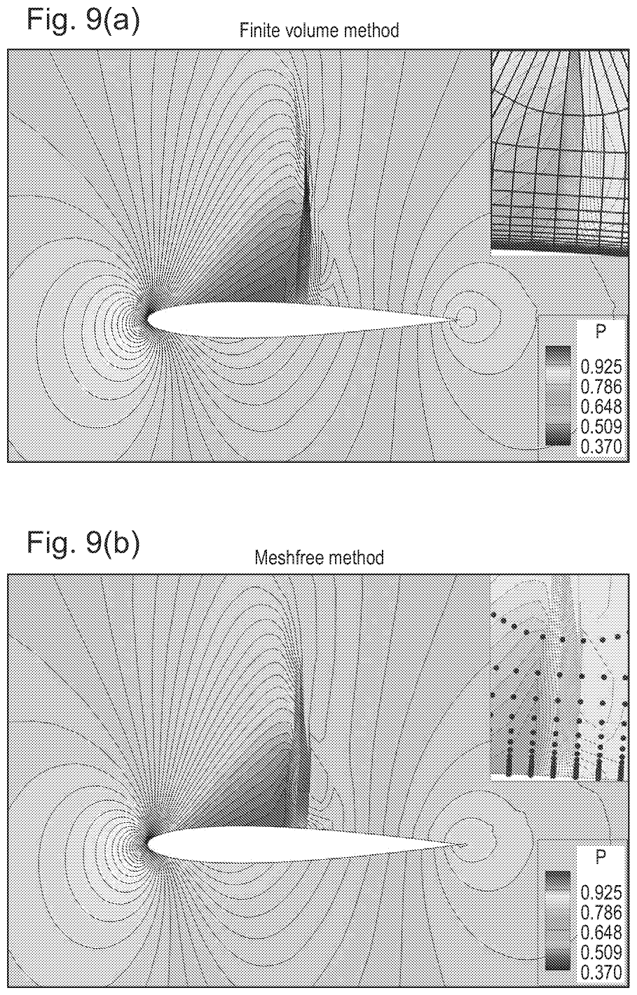

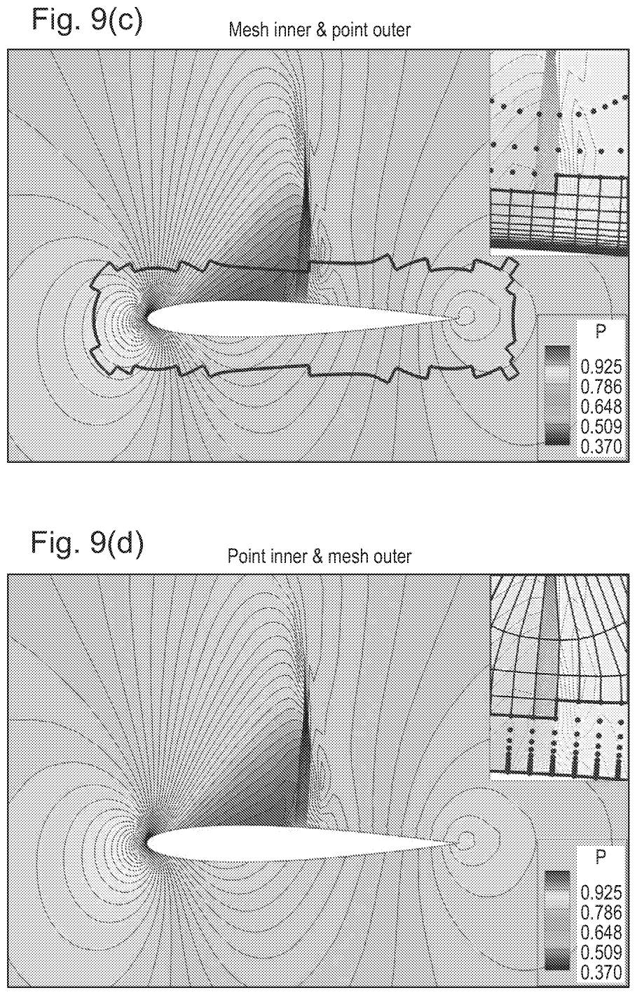

FIGS. 9(a) to 9(d) are plots of the flow field for the approaches of FIGS. 5(a) to 5(d), respectively, at Ma=0.775;

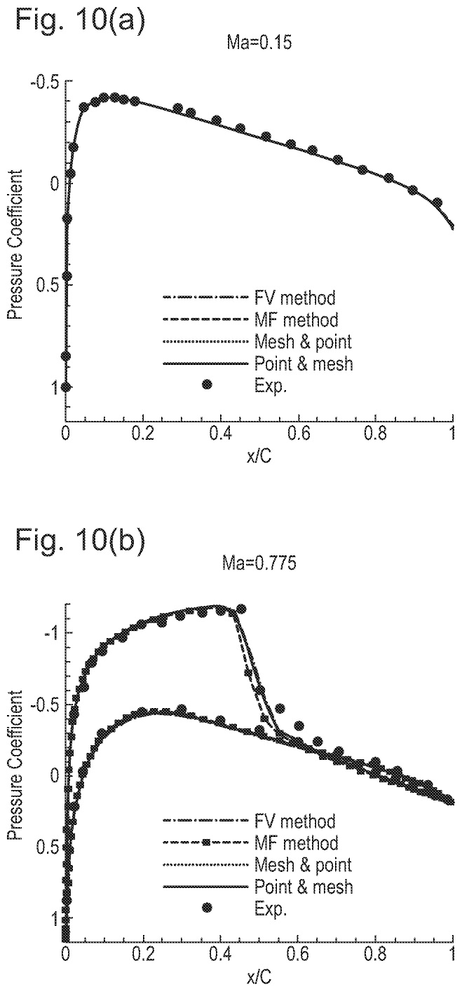

FIGS. 10(a) and 10(b) are graphs of a surface pressure coefficient at Ma=0.15 and Ma=0.775, respectively;

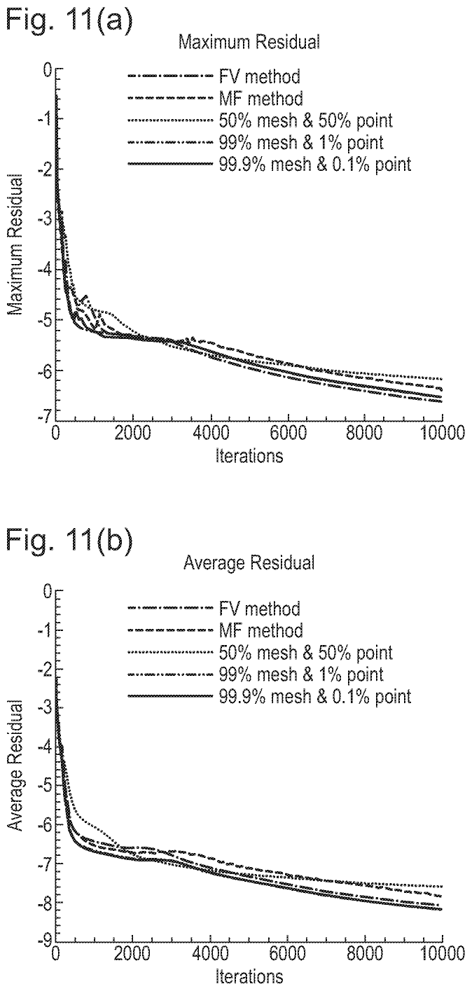

FIGS. 11(a) and 11(b) are graphs of convergence history of residuals at Ma=0.15, FIG. 11(a) showing the maximum residual and FIG. 11(b) showing the average residual;

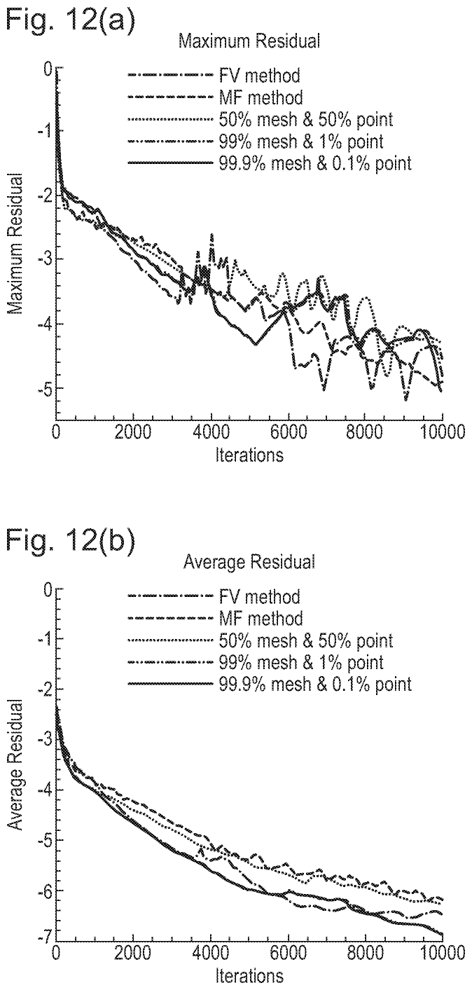

FIGS. 12(a) and 12(b) are graphs of convergence history of residuals at Ma=0.775, FIG. 12(a) showing the maximum residual and FIG. 12(b) showing the average residual;

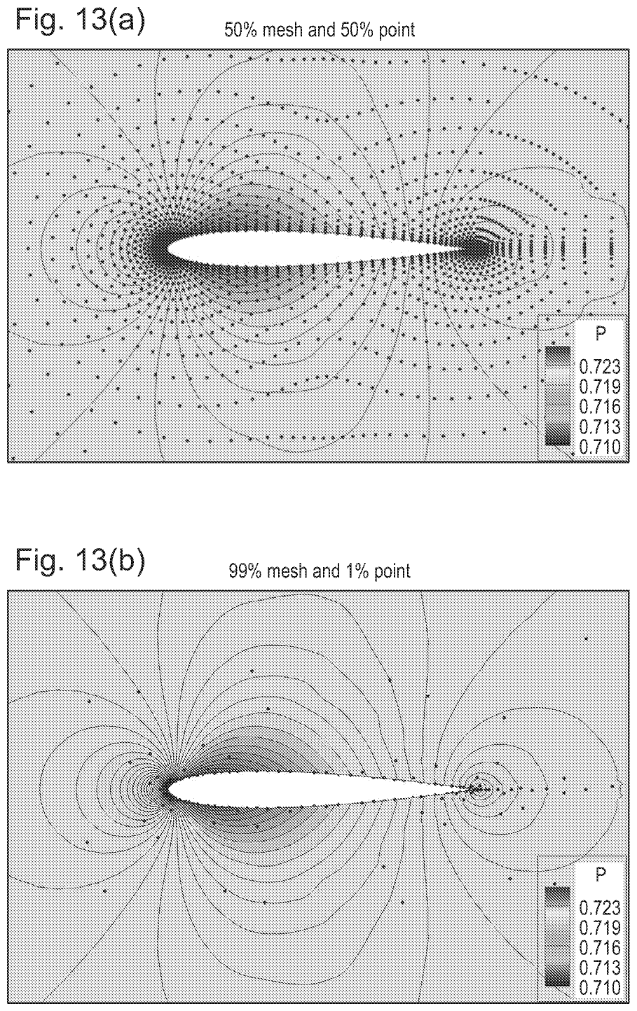

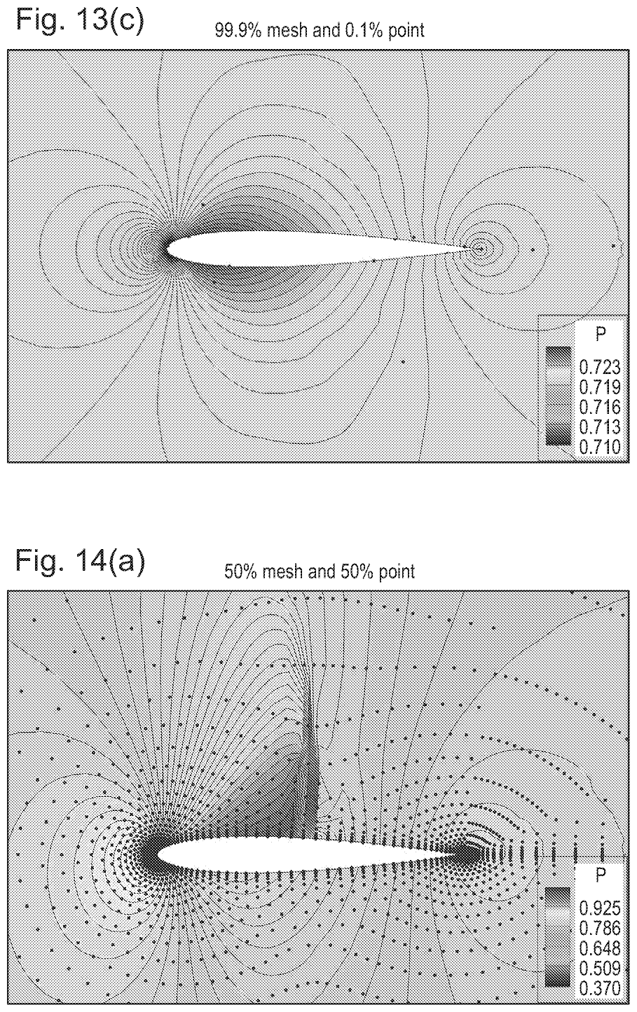

FIGS. 13(a) to 13(c) are plots of the flow field for the approaches of FIGS. 5(e) to 5(g), respectively, at Ma=0.15;

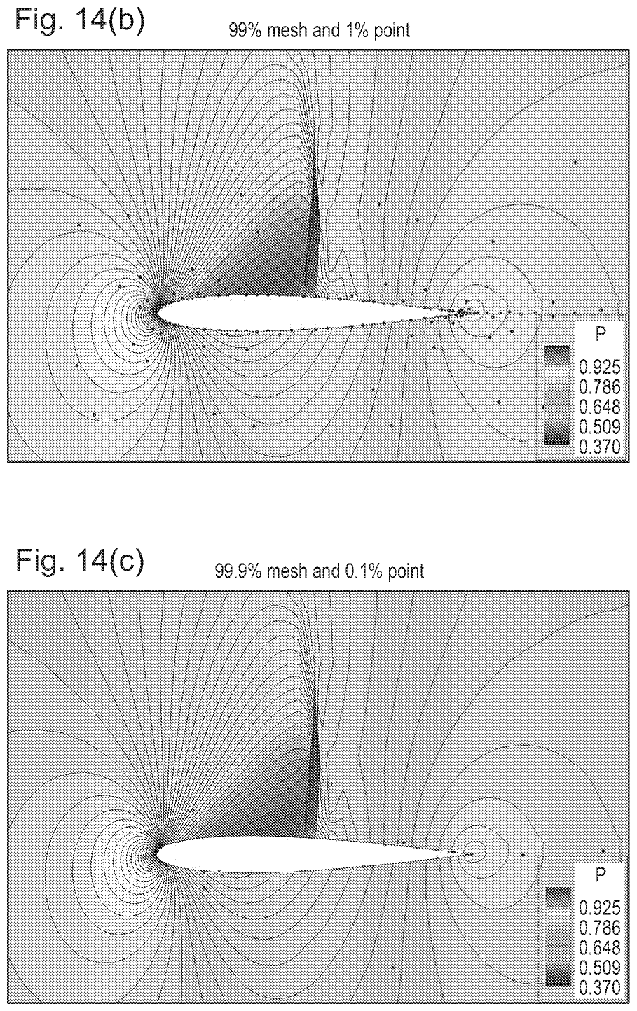

FIGS. 14(a) to 14(c) are plots of the flow field for the approaches of FIGS. 5(e) to 5(g), respectively, at Ma=0.775;

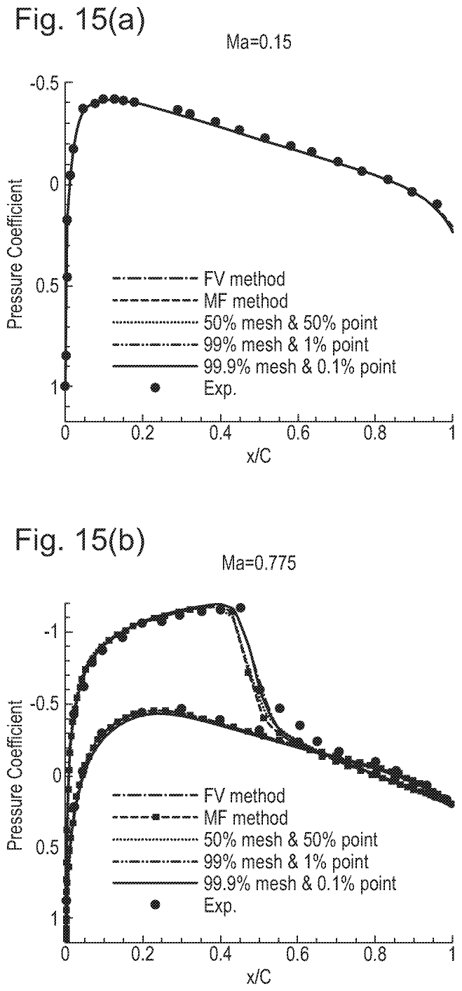

FIGS. 15(a) and 15(b) are graphs of a surface pressure coefficient at Ma=0.15 and Ma=0.775, respectively;

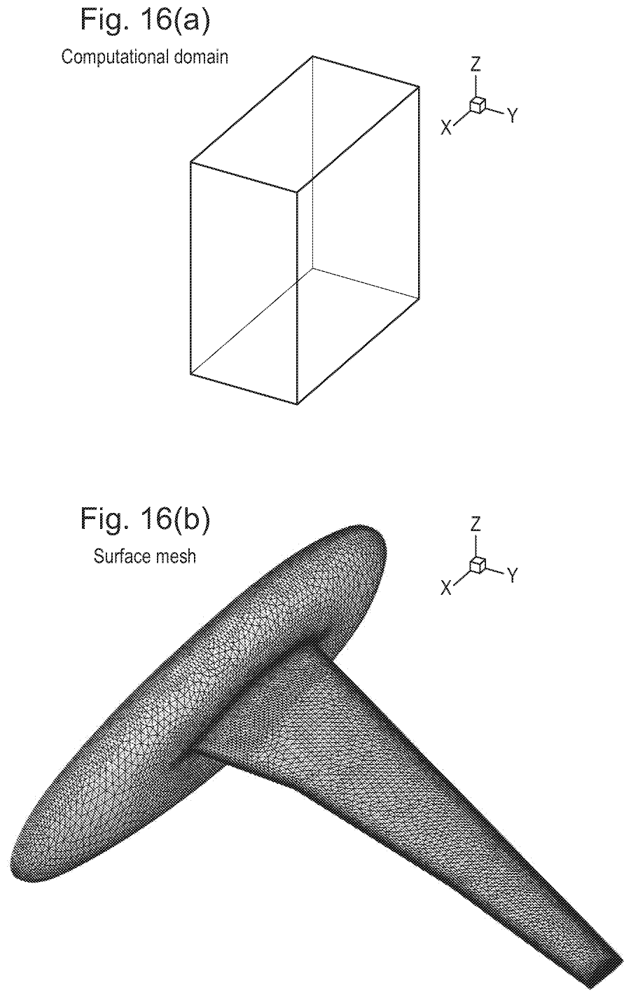

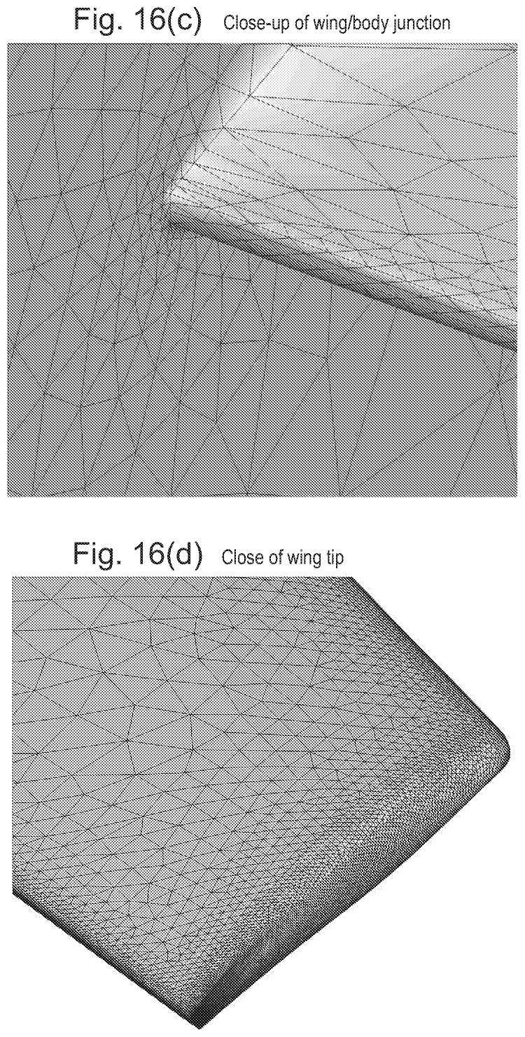

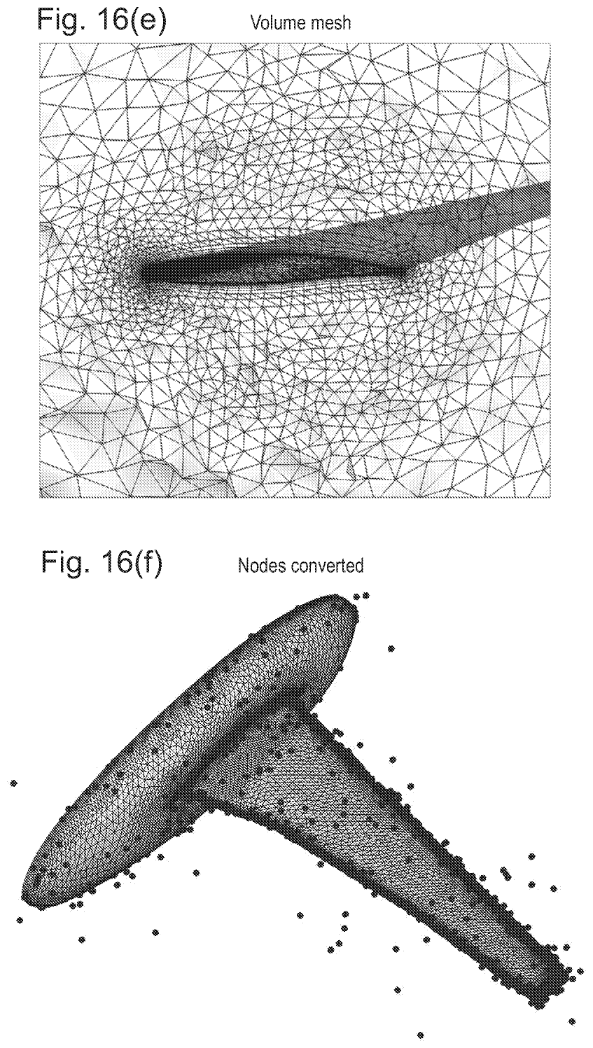

FIGS. 16(a) to 16(f) are plots of a general mesh for HIRENASD, FIG. 16(a) showing the computational domain, FIG. 16(b) showing the surface mesh, FIG. 16(c) showing a close-up of the wing/body junction; FIG. 16(d) showing a close-up of the wing tip; FIG. 16(e) showing the FV mesh; and FIG. 16(f) showing nodes selected as AV nodes;

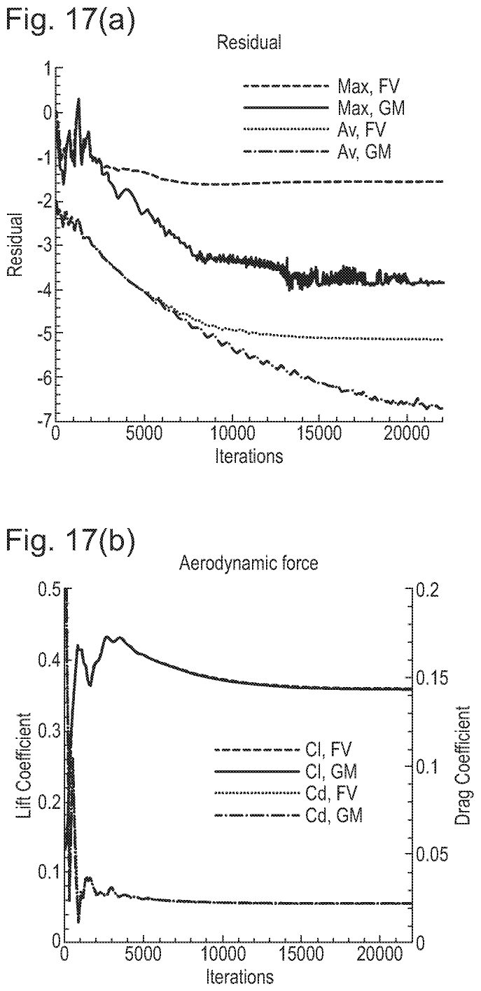

FIGS. 17(a) and 17(b) are graphs of convergence history of a residual and an aerodynamic force, respectively;

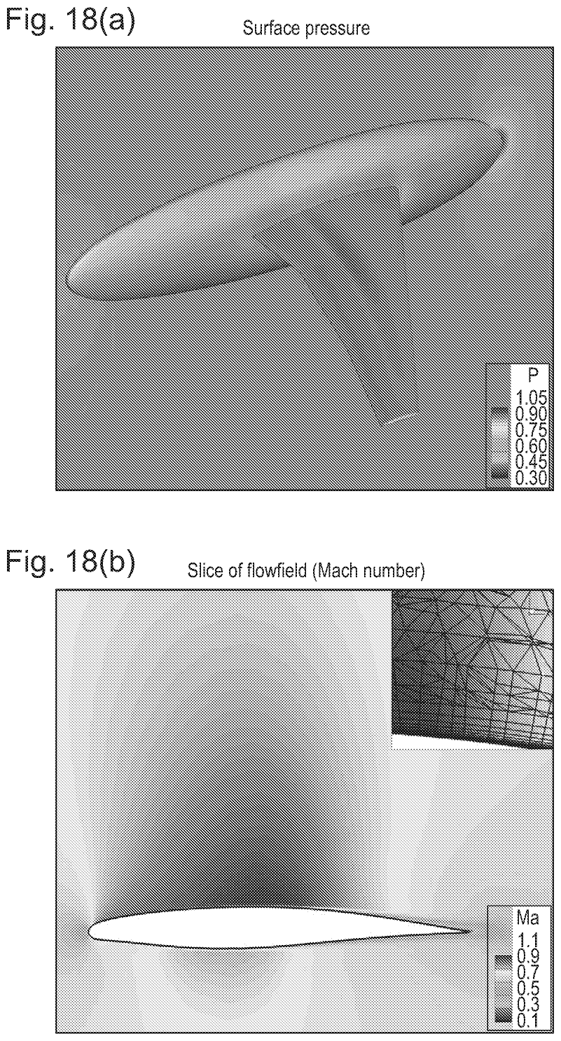

FIGS. 18(a) and 18(b) are plots the surface pressure and a slice of the flowfield, respectively, obtained by a general mesh method;

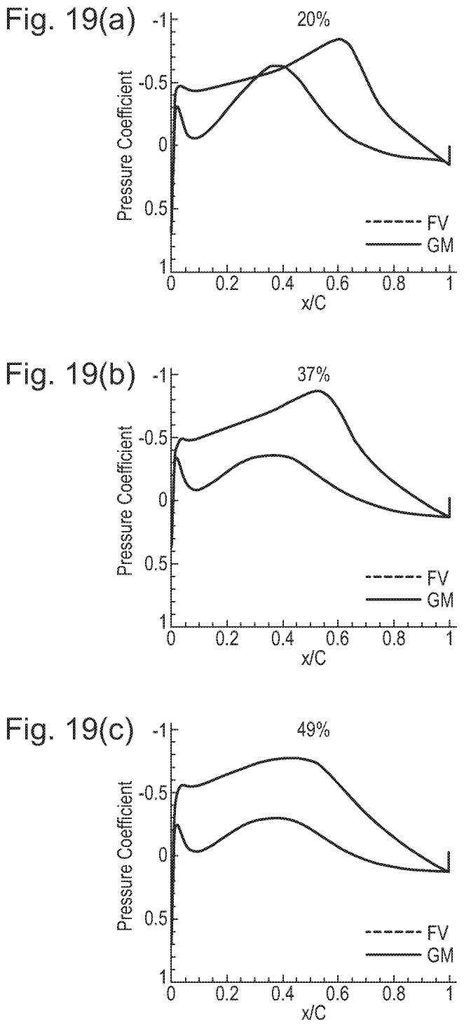

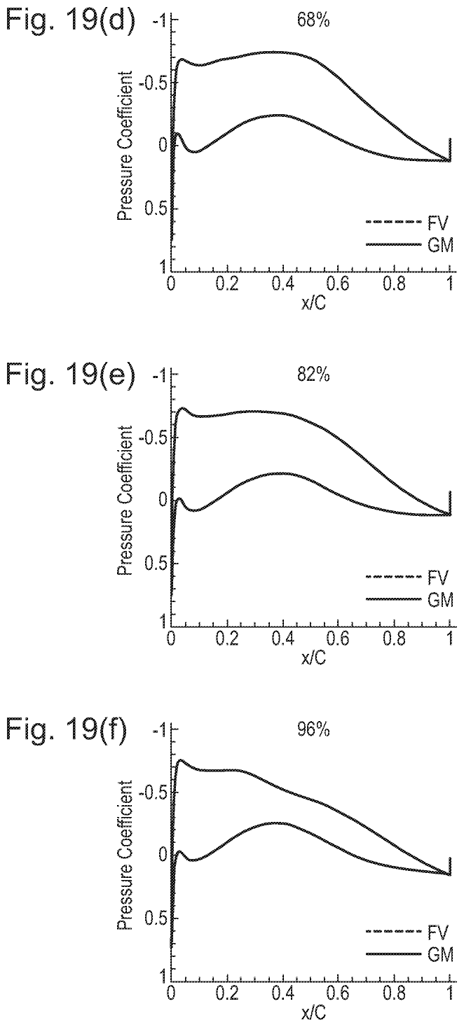

FIGS. 19(a) to 19(f) are plots of pressure coefficient at different stations (normalised by span), at 20%, 37%, 49%, 68%, 82% and 96%;

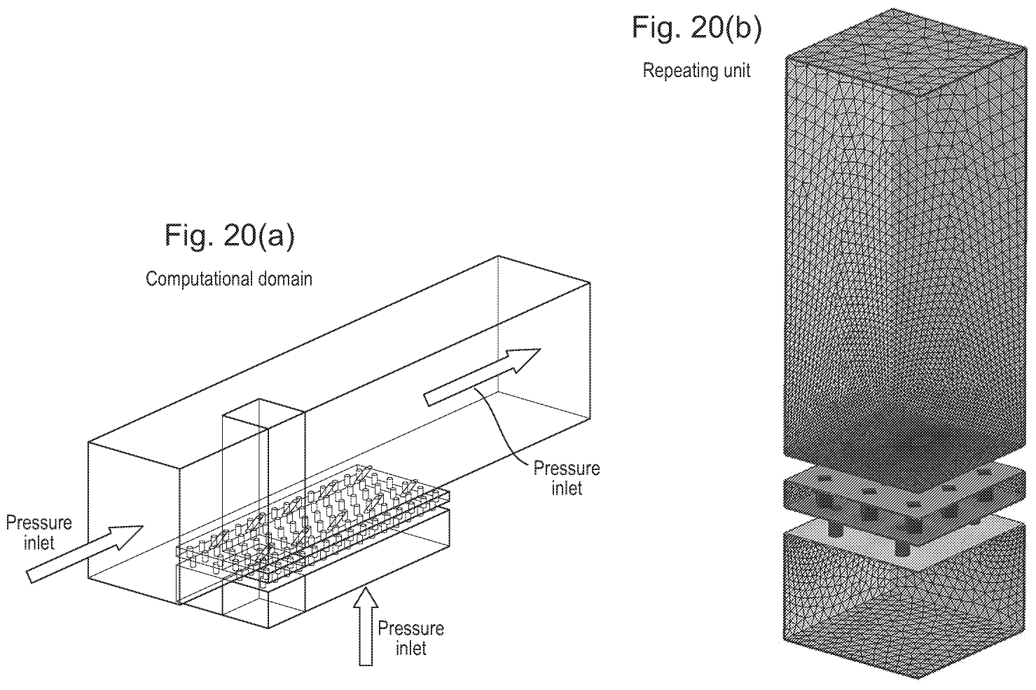

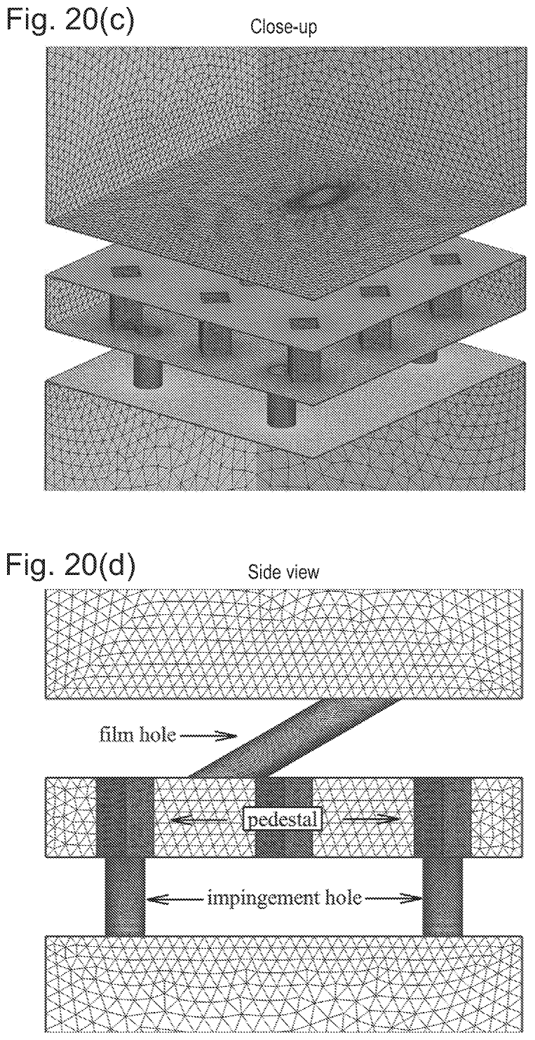

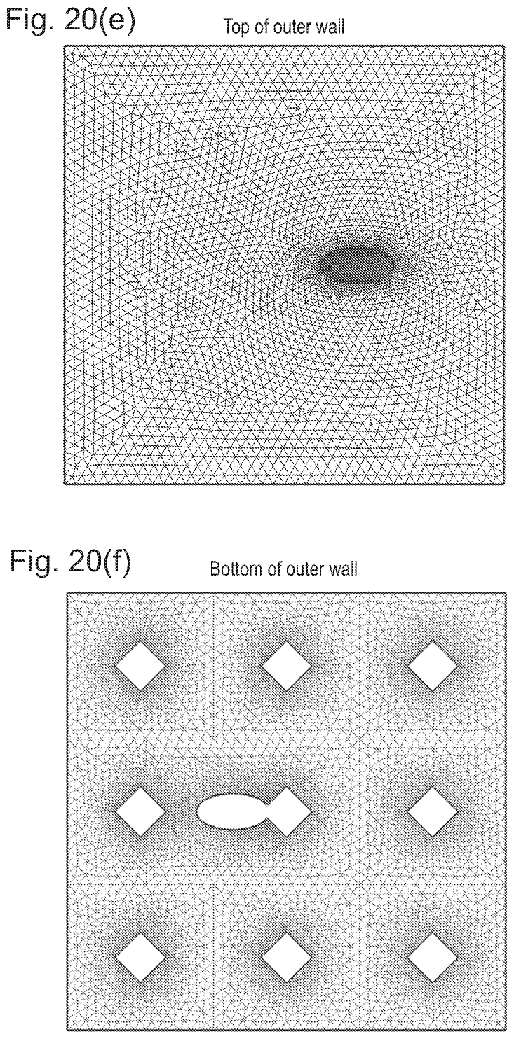

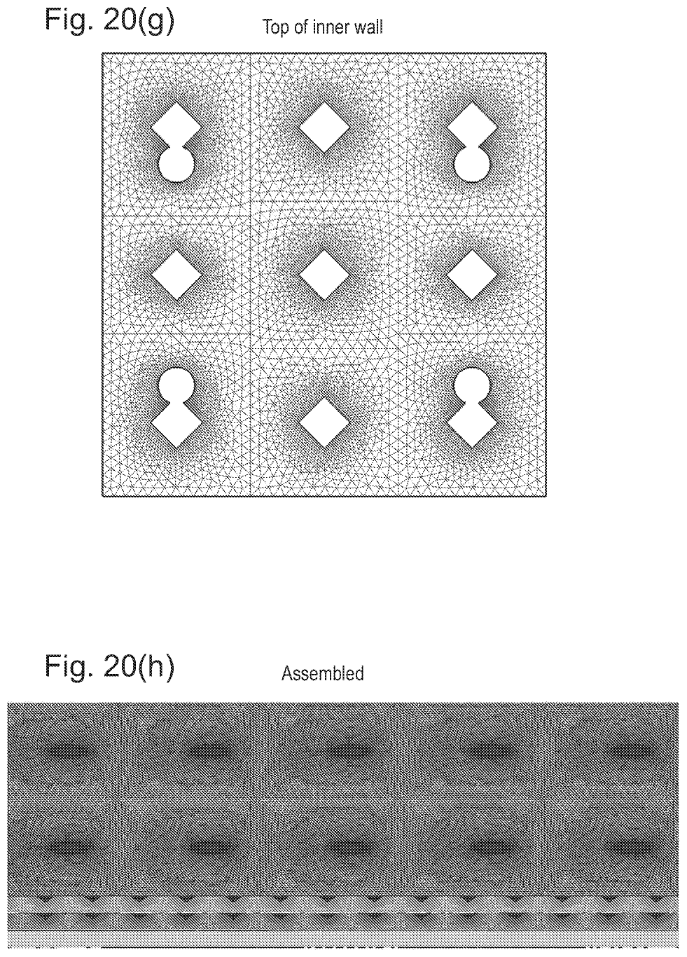

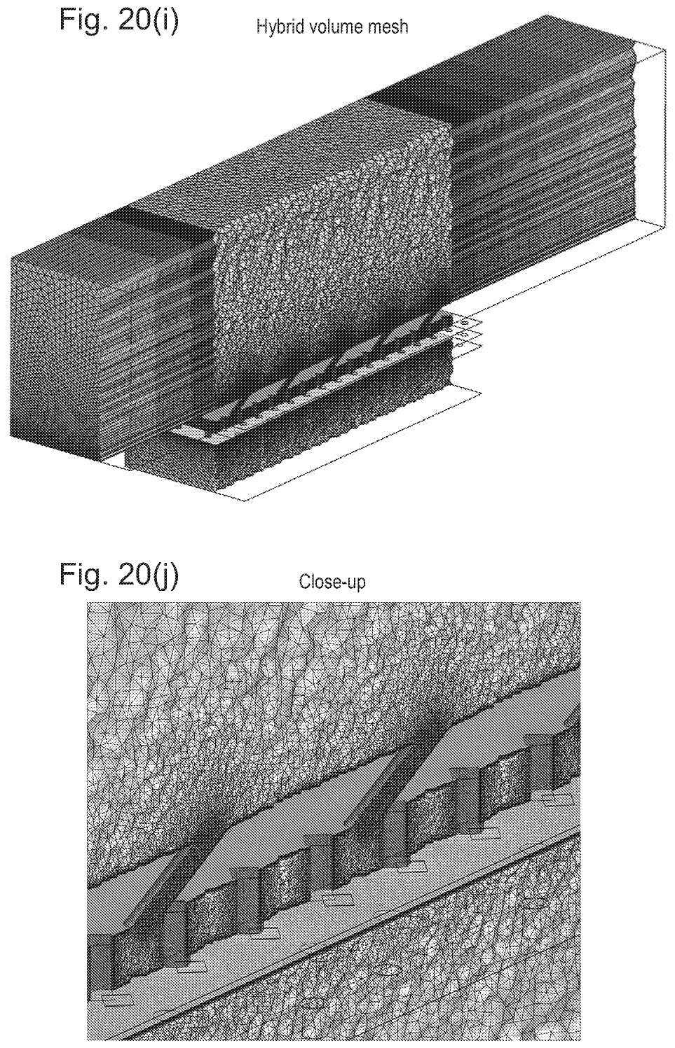

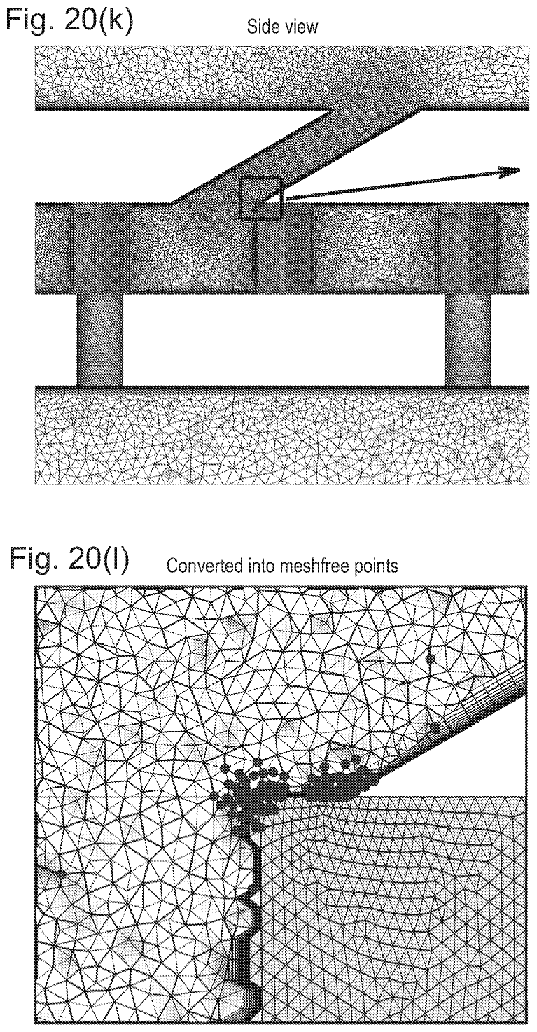

FIGS. 20(a) to 20(1) are plots of a general mesh for an example of a double wall effusion cooling configuration, FIG. 20(a) showing the computational domain, FIG. 20(b) showing a repeating unit, FIG. 20(c) showing a close-up of the double wall, FIG. 20(d) showing a side view of the double wall, FIG. 20(e) showing the top of the outer wall, FIG. 20(f) showing the bottom of the outer wall, FIG. 20(g) showing the top of the inner wall, FIG. 20(h) showing the regions of FIGS. 20(e) to 20(g) assembled together, FIG. 20(i) showing a hybrid FV mesh, FIG. 20(j) showing close-up of the double wall, and FIG. 20(k) showing a side view of the double wall, and FIG. 20(1) showing nodes selected as AV nodes;

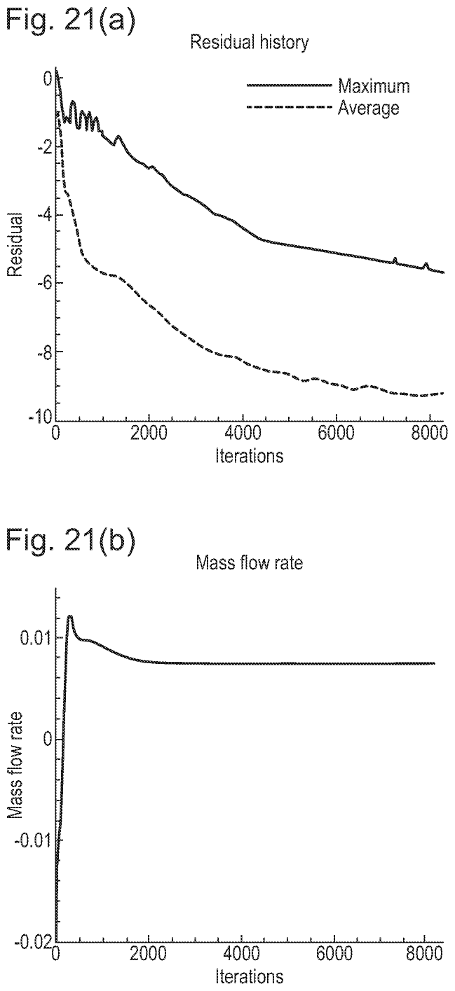

FIG. 21(a) is a plot of the convergence history of residuals for a simulation, and FIG. 21(b) is a plot of the mass flow rate in the simulation;

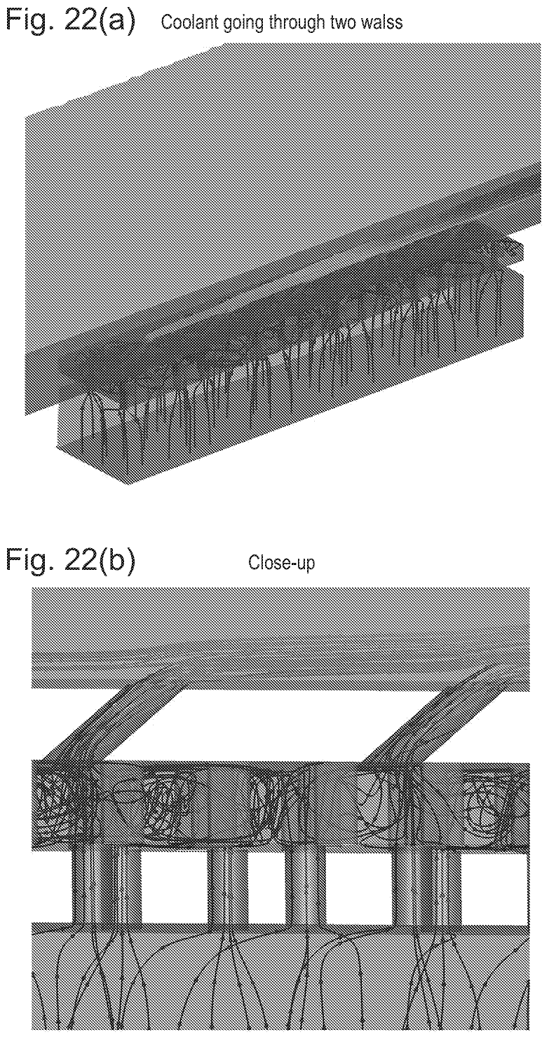

FIGS. 22(a) and 22(b) are respective 3D streamline plots of a system comprising coolant flowing between two walls, coloured to show the turbulence kinetic energy;

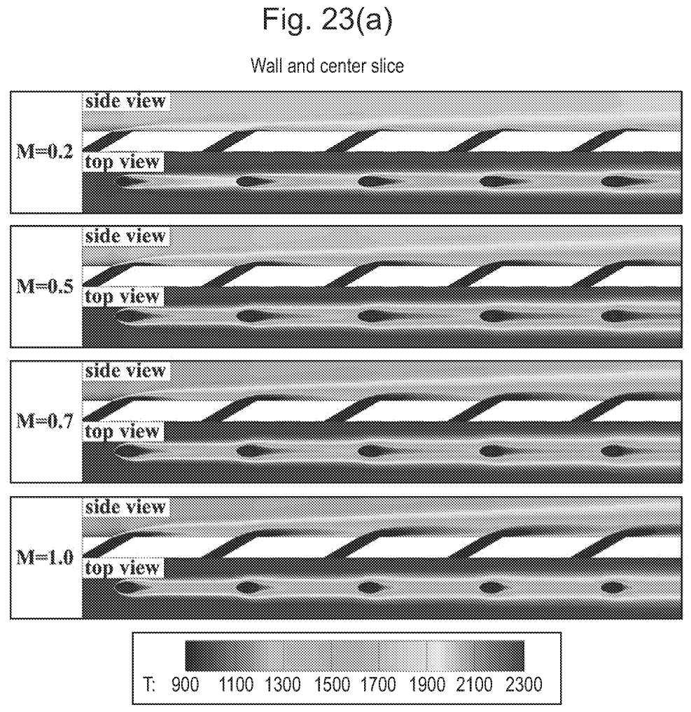

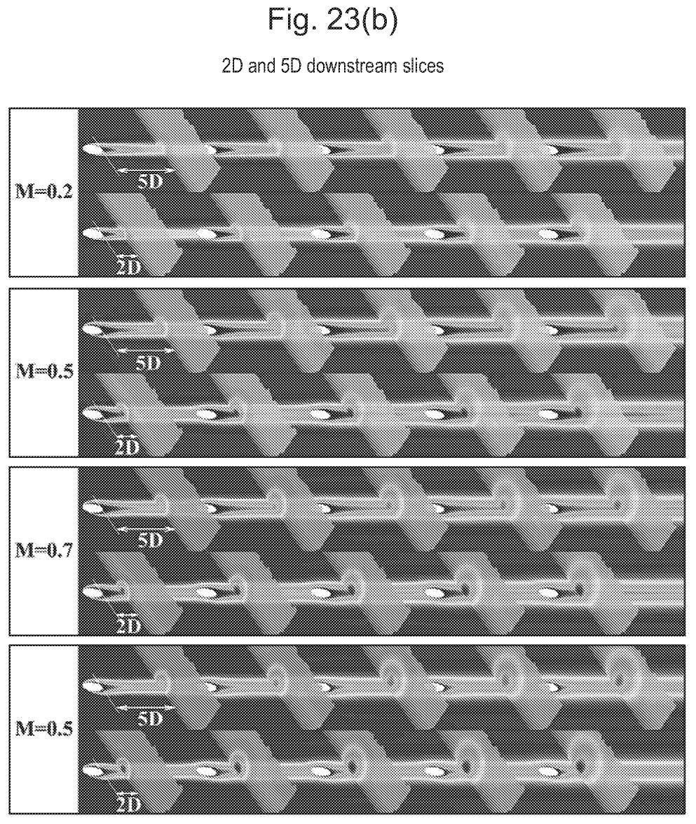

FIGS. 23(a) and 23(b) are plots of temperature fields at different blowing ratios, FIG. 23(a) showing a wall and centre slice, and FIG. 23(b) showing slices downstream of each film; and

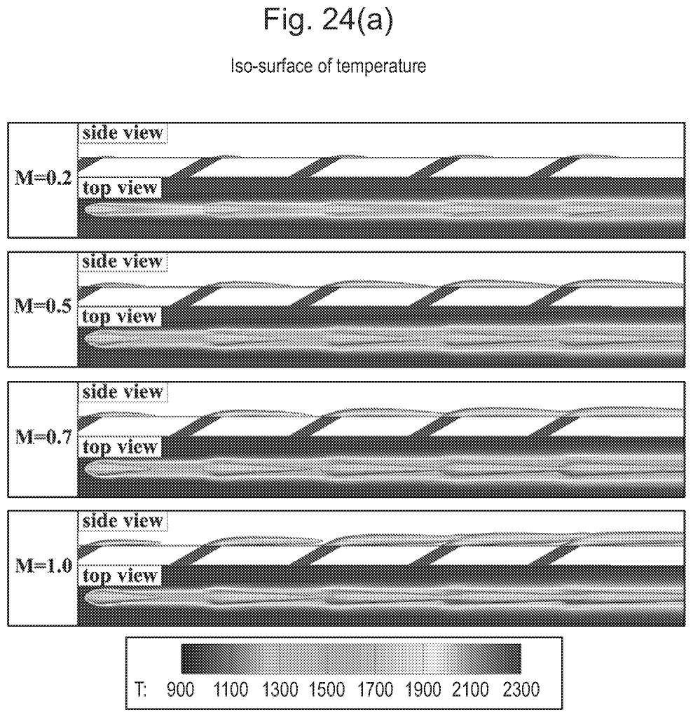

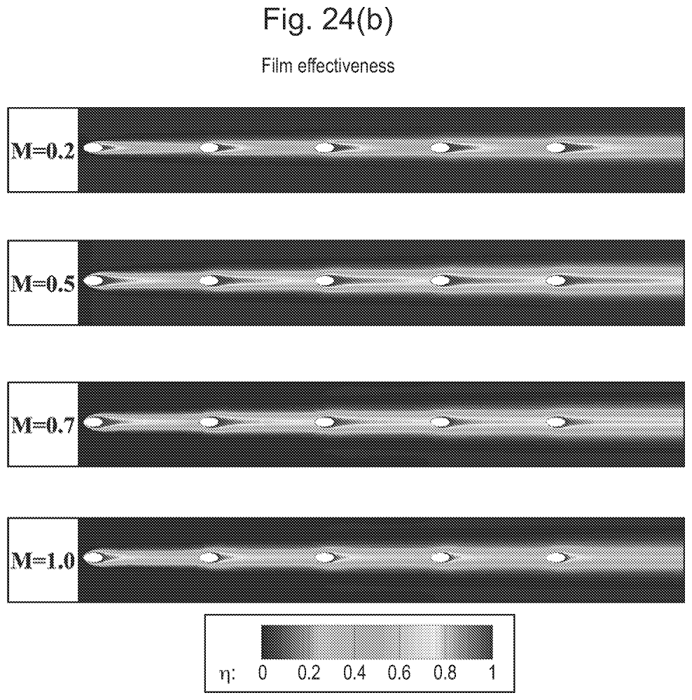

FIGS. 24(a) and 24(b) are plots of iso-surface temperature and film effectiveness, respectively, affected by a blowing ratio.

A method of computational analysis of a physical system is shown in FIG. 2.

The method may be implemented in a computer apparatus. To achieve this, a computer program capable of execution by the computer apparatus may be provided. The computer program is configured so that, on execution, it causes the computer apparatus to perform the method.

The computer apparatus, where used, may be any type of computer system but is typically of conventional construction. The computer program may be written in any suitable programming language. The computer program may be stored on a computer-readable storage medium, which may be of any type, for example: a recording medium which is insertable into a drive of the computing system and which may store information magnetically, optically or opto-magnetically; a fixed recording medium of the computer system such as a hard drive; or a computer memory.

The physical system is modelled by modelling equations representing relationships between physical properties of the physical system.

The physical system may any of a wide range of physical systems.

The physical system may be a fluid system and the present methods are of particular application to computational fluid dynamics (CFD).

By way of non-limitative example, the physical system may be a non-Newtonian fluid system, a magnetohydrodynamics system, conjugate heat transfer and plasma system, a solid mechanics system represented by PDEs

The physical system may be another advection-diffusion system having a physical property that is conserved, for example represented by modelling equations of the form:

$$\frac{\partial u}{\partial t} + ∇ \cdot f = 0$$

where u is conserved quantity, f=f (u, ∇u) is the flux of this conserved quantity and V is the gradient operator.

By way of illustration, there will be described herein an example where the physical system is a fluid system and the modelling equations are the Navier-Stokes (NS) equations, including modifications for inviscid flow. In this example, the modelling equations may take the following form.

The NS equations represent a classic computational physics model. The NS equations are typical advection-diffusion equations which describes the motion of Newtonian fluid. The integral form of the Navier-Stokes (NS) equations can be written as follows:

$$\frac{\partial }{\partial t} \int \int {\int }_{Ω} Q dV + \int {\int }_{\partial Ω} F ( Q ) \cdot ndS = \int {\int }_{\partial Ω} {F}^{v i s} ( Q ) \cdot ndS \qquad ( 1 )$$

where t is time. Ω and ∂Ω are the volume and boundary of discrete control volume, respectively, n stands for the unit outward-normal vector of the control volume face θΩ, V is the volume (area in 2D) of Ω, and S denotes the area (length in 2D) of ∂Ω.

The conservative flow variable vector Q, inviscid flux vector F(Q), and viscous flux vector F^{vis}(Q) are given by

$$Q = [ \begin{matrix}ρ \\ ρ u \\ ρ v \\ ρ w \\ ρ {e}_{0}\end{matrix} ] \qquad ( 2 )$$

$$F ( Q ) \cdot n = [ \begin{matrix}ρ v \cdot n \\ ρ uv \cdot n + P {n}_{x} \\ ρ vv \cdot n + P {n}_{y} \\ ρ wv \cdot n + P {n}_{z} \\ ( ρ {e}_{0} + P ) v \cdot n\end{matrix} ] \qquad ( 3 )$$

$${F}^{v i s} ( Q ) \cdot n = [ \begin{matrix}0 \\ {τ}_{x x} {n}_{x} + {τ}_{x y} {n}_{y} + {τ}_{x z} {n}_{z} \\ {τ}_{y x} {n}_{x} + {τ}_{y y} {n}_{y} + {τ}_{y z} {n}_{z} \\ {τ}_{z x} {n}_{x} + {τ}_{z y} {n}_{y} + {τ}_{zz} {n}_{z} \\ {σ}_{x} {n}_{x} + {σ}_{y} {n}_{y} + {σ}_{z} {n}_{z}\end{matrix} ] \qquad ( 4 )$$

respectively. ρ, P, and e₀ denote the density, static pressure, and specific total energy per unit mass, respectively. v stands for the velocity vector of which u, v, and w are the components. nₓ, n_{y}, and n_{z} are the components of normal vector n. The viscous stress tensor reads:

$$\{ \begin{matrix}{τ}_{x x} = 2 ( μ + t ) \frac{\partial u}{\partial x} - \frac{2}{3} ( μ + {μ}_{t} ) ( \frac{\partial u}{\partial x} + \frac{\partial v}{\partial y} + \frac{\partial w}{\partial z} ) \\ {τ}_{y y} = 2 ( μ + {μ}_{t} ) \frac{\partial v}{\partial y} - \frac{2}{3} ( μ + {μ}_{t} ) ( \frac{\partial u}{\partial x} + \frac{\partial v}{\partial y} + \frac{\partial w}{\partial z} ) \\ {τ}_{zz} = 2 ( μ + {μ}_{t} ) \frac{\partial w}{\partial z} - \frac{2}{3} ( μ + {μ}_{t} ) ( \frac{\partial u}{\partial x} + \frac{\partial v}{\partial y} + \frac{\partial w}{\partial z} ) \\ {τ}_{x y} = {τ}_{y x} = ( μ + {μ}_{t} ) ( \frac{\partial u}{\partial y} + \frac{\partial v}{\partial x} ) \\ {τ}_{x z} = {τ}_{z x} = ( μ + {μ}_{t} ) ( \frac{\partial u}{\partial z} + \frac{\partial w}{\partial x} ) \\ {τ}_{y z} = {τ}_{z y} = ( μ + {μ}_{t} ) ( \frac{\partial v}{\partial z} + \frac{\partial w}{\partial y} )\end{matrix} \qquad ( 5 )$$

and the abbreviations σₓ, σ_{y}, and σ_{z} are given by

$$\{ \begin{matrix}{σ}_{x} = u {τ}_{x x} + v {τ}_{x y} + w {τ}_{x z} + κ \frac{\partial T}{\partial x} \\ {σ}_{y} = u {τ}_{y x} + v {τ}_{y y} + w {τ}_{y z} + κ \frac{\partial T}{\partial y} \\ {σ}_{z} = u {τ}_{z x} + v {τ}_{z y} + w {τ}_{zz} + κ \frac{\partial T}{\partial z}\end{matrix} \qquad ( 6 )$$

with κ representing the thermal conductivity coefficient

$$κ = \frac{γ R}{γ - 1} ( \frac{μ}{{P}_{r}} + \frac{{μ}_{t}}{{P}_{r t}} ) \qquad ( 7 )$$

where Pᵣ and Pᵣₜ are the laminar and turbulent Prandtl numbers and their values are 0.72 and 0.9, respectively. T stands for the static temperature. γ is the ratio of specific heat coefficient. R represents the specific gas constant. μ and μₜ denote the molecular viscosity and turbulent viscosity, respectively. The former is calculated by the Sutherland's law

$$μ = \frac{1.45 {T}^{3 / 2}}{T + 110} \times 1 {0}^{- 6} \qquad ( 8 )$$

The extra turbulent model is required to obtain the turbulent eddy viscosity μₜ, such as Spalart-Allmaras (SA) disclosed in Reference [19], or k−ω SST disclosed in Reference [20], etc.

Additionally, for the perfect gas

$$\{ \begin{matrix}T = \frac{P}{ρ R} \\ P = ρ ( γ - 1 ) ( {e}_{0} - \frac{1}{2} {‖ v ‖}^{2} )\end{matrix} \qquad ( 9 )$$

The method of FIG. 2 is performed as follows.

In step S1, a mesh of discrete nodes are generated. This is the spatial decomposition of the computational domain that is a continuous geometric space. The domain is meshed into a serial, large number of discrete nodes.

For most practical applications, the nodes are spatially distributed in three dimensions (3D). Alternatively, for some applications the nodes may be spatially distributed in two dimensions (2D).

As described below, volumes are associated with each node. Herein, the term “volume” is used to refer to a control volume, that is a geometric cell (region of space). In the is context, the term “volume” refers to that entity, not the size of that entity. For clarity, the term “size”, rather than “volume”, is used to refer to the size of the volume.

When the nodes are spatially distributed in three dimensions, the volume is a three dimensional region of space and the size is measured in units of volume. Such volumes may take any suitable form, for example tetrahedron, prism, pyramid, hexahedron, or any arbitrary polyhedron.

When the nodes are spatially distributed in two dimensions, the volume is a two dimensional region of space (i.e. an area) and the size is measured in units of area. Such volumes may take any suitable form, for example triangle, quadrilateral, or any arbitrary polygon.

Parameters of the volumes associated with each node are derived in one of two different ways that are described in more detail below. For ease of reference, volumes whose parameters are derived from the solutions of the geometrical equations will be referred to as “finite volumes” and the nodes associated therewith will be referred to as “finite volume nodes”. As an alternative, the term “finite volume” could be replaced by “geometric volume”.

Similarly, volumes whose parameters are derived from using the algebraic techniques described below will be referred to as “algebraic volumes” and the nodes associated therewith will be referred to as “algebraic volume nodes”.

The method uses an integral form of the modelling equations that is discretised into equations in respect of volumes associated with respective nodes of the mesh. For ease of reference these equations in in respect of volumes associated with respective nodes will be referred to as “volume equations”.

The volume equations in respect of each volume representing the relationship between the size of the volume, the face area vectors between the respective volume and neighbouring volumes in the mesh, and fluxes across the face areas.

The numerical schemes of the volume equations are designed and implemented over the closed faces of the volumes volume to calculate the fluxes. By way of illustrative example, FIG. 3(a) illustrates a 2D example of vertex-based finite volume associated with node m. In this example, there are six neighbouring nodes n, n₁, . . . , n₅. And the geometric connections between the node m and each respective neighbouring node n, n₁, . . . , n₅ are shown. The volume is bounded by a respective face areas between the node m and each of the neighbouring nodes n, n₁, . . . , n₅, depicted by solid lines. A face area vector ΔS_{m,p} is associated with each face area, where m represents the node and p represents the p-th face recorded through the p-th edge for edge-based data structure.

For the general case that a node m is closed by N(m) faces recorded in set Ξ(m), namely, n, n₁, . . . , n₍ₘ₋₁₎ and node np represents the p-th neighbour of node m.

As an illustration in the case that the modelling equations are the NS Equation (1), then for an arbitrary polygonal finite volume m (polyhedron in 3D), the volume equation derived by the discretization of NS Equation (1) can be expressed as follows:

$$\frac{d ( {Q}_{m} {V}_{m} )}{dt} + {\sum }_{p ∈ Ξ ( m )} F ( {Q}_{m , p} ) \cdot Δ {S}_{m , p} = {\sum }_{p ∈ Ξ ( m )} {F}^{vis} ( {Q}_{m , p} ) \cdot Δ {S}_{m , p} \qquad ( 12 )$$

where Qₘ is the vector of conservative flow variables at the centroid of the control volume, representing the averaged value of control volume m, Q_{m,p} stands for the vector of reconstructed flow variables at the centroid of its p-th face, representing the averaged value of face, Ξ(m) represents the set of faces of control volume m, and Vₘ is the size of the control volume m. ΔS_{m,p} denotes the face area vector of p-th face of control volume m. The vector ΔS_{m,p}=n_{m,p} ΔS_{m,p}, where ΔS_{m,p} represents the area of p-th face.

In general, step S1 may utilise any technique for selection of the nodes. Various approaches are known and may be applied here. Step S1 may employ any of the mesh generation methods known for structured and unstructured meshes, including any of those taught in the documents discussing structured and unstructured meshes that are acknowledged in the introduction.

The meshing strategy may be chosen in combination with the numerical methods applied in the solution of the modelling equations described below.

The mesh generation may be adapted to the physical system which is being modelled. As an example, modelling of a viscous wall may be performed as follows. A high aspect-ratio prismatic mesh may be generated near the viscous wall to solve the boundary layer, and a traditional tetrahedral mesh may be generated in other areas.

The tetrahedron mesh generation method may use known techniques that have been well developed.

Meshing of the boundary layer may use an advancing layer method, for example as disclosed in Reference [21], which is an effective method to generate a high aspect ratio mesh near a wall. However, it is not easy to handle the collision problem of the boundary layer elements. It is possible to use several methods to solve the mesh collision problem, for example as disclosed in References [22, 23]. An alternative efficient and simple strategy is presented here.

The main idea is as follows: firstly, a tetrahedral mesh is generated to decompose the entire computational domain; then the advancing layer method is employed to create the high aspect ratio boundary layer mesh near the viscous wall (or walls). Since the space of computational domain has been filled with a tetrahedral mesh, a dynamic mesh method frequently adopted for unsteady flow simulations with boundary movement is applied to continuously move the tetrahedral mesh in the process of generating the prismatic boundary layer mesh. The arbitrary-topology mesh and meshfree point are employed to handle the meshing failure and improve the quality of mesh.

The algorithm is summarized in the following outline.

(1) Mesh the entire computational domain using tetrahedral mesh. This is the initial mesh;

(2) Extract the triangular elements on the viscous wall from the tetrahedral mesh. Record the cells and node;

(3) Calculate the ideal growing direction (vector) for each viscous boundary node;

(4) The advancing layer method is adopted to generate the high aspect ratio elements. All the nodes on the viscous wall are the initial set of advancing layer. The boundary layer mesh is generated layer by layer. The criterion for stopping the growth of a boundary layer element is somewhere the growing height reaches the settings or the mesh quality of corresponding elements becomes lower than user definition. Cycle until all nodes of advancing layer set achieve the stopping criterion:

(a) Generate a new layer for node i if it does not reach the stopping criterion on the advancing layer.

(b) Calculate the advancing height using the settings of boundary layer mesh, and record its corresponding position of the new node i_{new};

(c) The position of the new node i_{new} is used as a moved boundary node to push the tetrahedral mesh by using dynamic mesh method. Then the moved tetrahedral mesh is optimized and smoothed. If the volume of some elements is negative or the quality is lower than the user setting, a process will try to locally remove these elements and the corresponding nodes are re-connected to re-generate the tetrahedral elements. If this attempt is failed to re-generate mesh, the new added node i_{new} will be deleted. It means that node i and its neighbours have satisfied the stopping criterion. Mark them and remove from the advancing layer set;

(d) The node i is replaced by new node i_{new} in the advancing layer.

FIG. 4 shows a case for generation of very high advancing layer mesh. The geometry is the front fuselage of a space shuttle. The setting of the height of boundary layer mesh is higher than the size of entire domain. It is applied to test the capability of the proposed advancing layer method. The final mesh has some characteristics of structured mesh at normal direction of fuselage. The meshing can automatically smooth, delete, and regenerate some tetrahedral elements as boundary layer elements are growing. The final layer is already connected to the far-field boundary of which the boundary mesh is not allowed to delete or move. So the advancing layer actually reaches the maximum height. These demonstrations indicate that the mesh generation method is robust.

Thus, the traditional tetrahedral mesh is generated in the entire computational domain at the beginning. The prismatic meshing advances layer by layer in boundary layer. Thus the boundary of tetrahedral mesh is also moved as new prismatic mesh layer is added. This behaviour is similar to an inflation of wall boundary. It gradually pushes the tetrahedral mesh. The idea of dynamic mesh is to effectively transport the motion of boundary (interface between new-added mesh and old-existing tetrahedral mesh) into the mesh nodes of inner field. Because the volume of the elements near the moved boundary may become negative due to the movement of boundary. It becomes more possible when the size of the first cell adjacent to wall is small.

The position of the boundary nodes is known. It is the outer layer of the boundary layer mesh. So the displacement of each boundary node can be obtained according to the position change between the previous and current location. Radial Basis Function (RBF) based dynamic mesh method as disclosed in References [24-27] may be employed.

In step S2, there are derived parameters of the finite volumes associated with each node. These parameters are the sizes of finite volumes associated with each finite volume node and face area vectors between the respective finite volume and neighbouring volumes in the mesh (which may in general be finite volumes or algebraic volumes). These parameters are derived from solutions of geometrical equations representing the geometry of the finite volumes. This step may be performed in a conventional manner that is known for structured and unstructured meshes.

By way of illustration, when the volume equations take the form shown in Equation (12) above, this step involves derivation of the size Vₘ of the control volume m and the face area vectors ΔS_{m,p}.

It is important to note that in the subsequent steps described below algebraic volumes are associated with some of the nodes. Thus, in respect of those algebraic volume nodes, the sizes and face area vectors derived in step S2 are not used in the numerical solution performed in step S7 below. Steps S3 and S4 use measures of mesh quality to select whether the volumes associated with nodes are finite volumes or algebraic volumes, as follows.

In step S3, there is derived at least one measure of quality of a finite volume associated with each node.

Mesh quality significantly affects the accuracy, stability and convergence of numerical simulation. There are lots of different definitions of mesh quality such as aspect ratio, skewness, smoothness and orthogonal quality any of which may be applied here.

One example is that it is possible to use the size of the volume, because low or negative size is indicative of a poor quality volume. This measure of quality is particularly significant and preferably is one of the measures used, along with one or more other measures.

Other measures are described in Reference [28], any of which may applied. Non-limitative measures of quality that may be used and are described in more detail in Reference [28] are (a) a measure of aspect ratio of the finite volume, this being a measure of the stretching of the volume; (b) a measure of skewness of the mesh in the locality of the node; (c) a measure of smoothness of transitions in the size of finite volumes associated with neighbouring nodes in the locality of the node; and/or (d) an orthogonal quality of the finite volume, which may for example be determined based on the vector normal to each face, the vector from the volume centroid to the centroids of each of the adjacent volumes, and the vector from the volume centroid to each of its faces.

In step S4, nodes that are indicated by the at least one measure of quality to be of low quality are selected as algebraic volume nodes and other nodes are selected as finite volume nodes. The selection may be based on the measures of quality that may be used together in any suitable way, for example using an overall measure of quality that combines the individual measures and comparing that to a threshold, and/or by comparing the individual measures with respective thresholds. More generally, any classification technique may be used to class the set of measures of quality as indicating the node is of high or low quality.

As an alternative to selecting nodes as algebraic volume nodes in Step S4 on the basis of the measures of quality derived in step S3, nodes may be selected as algebraic volume nodes on the basis of other criteria. Some non-limitative examples are as follows.

In one example, nodes located around a moving object may be selected as algebraic volume nodes. One option for implementing this is to adapt step S3 to derive a measure of distance from an object in the physical system and to adapt step S4 to select nodes as algebraic volume nodes on the basis of the measure of distance derived in step S3, for instance if the distance is at or below a threshold.

In another example, nodes may be selected as algebraic volume nodes on the basis of user input. This allows an engineer to decide the nodes on which the benefits of the present method are obtained.

An important point is that the numerical techniques of the following steps described below may be applied for any arbitrary selection of nodes as being algebraic volume nodes or finite volume nodes.

Parameters of the algebraic volumes are derived in step S5. These parameters are the sizes of algebraic volumes associated with each finite volume node and face area vectors between the respective algebraic volume and neighbouring volumes in the mesh (which may in general be finite volumes or algebraic volumes).

The sizes and face area vectors are derived to provide volume equations in respect of the algebraic volume nodes that have a unified representation with the volume equations in respect of the finite volume nodes. Thus, by comparison with the finite volume shown in FIG. 3(a), an algebraic volume associated with the same node m is shown in FIG. 3(b). The algebraic volume is bounded by a respective face areas between the node m and each of the neighbouring nodes n, n₁, . . . , n₅, depicted in this case by curved lines to illustrate the fact that the locations of these face areas are not geometrically defined or known. Nonetheless, a face area vector ΔS_{m,p} is associated with each face area.

For the general case, in the same manner as for finite volumes, in the case of algebraic volumes, for a node m is closed by N(m) faces recorded in set Ξ(m), namely, n, n₁, . . . , n₍ₘ₋₁₎ and node np represents the p-th neighbour of node m, it remains the case that the algebraic volume has a unified representation by a size Vₘ face area vectors ΔS_{m,p} associated with each face area.

By way of illustration, when the volume equations for the finite volumes take the form shown in Equation (12) above, the geometric parameters Ξ(m), Vₘ, and ΔS_{m,p} are the key variables to construct the numerical schemes for finite volume method, these parameters being inherently contained by the geometric control volume. While the geometric parameters Ξ(m) relates to the geometry of the nodes themselves, for the algebraic volumes the size Vₘ, and face area vectors ΔS_{m,p} are not defined geometrically, which may be thought of as resulting from the absence of geometric connection between the nodes. Thus, these parameters are derived as follows.

In step S5, the sizes of algebraic volumes associated with each finite volume node and face area vectors between the respective algebraic volume and neighbouring volumes in the mesh are derived from solutions of discretized differential flux equations for each algebraic volume representing fluxes between the respective algebraic volume and each neighbouring volume in the mesh, as follows.

Step S5 may use the algebraic volume methods proposed in Reference [29] and as will now be described. The following example relates to the case that the modelling equations are the NS equations. However, this is merely for illustration, and the methods may be generalised to any other form of the modelling equations to which the present methods apply, as disclosed above.

The differential form of NS equations can be written as follows:

$$\frac{\partial Q}{\partial t} + ( \frac{\partial F}{\partial x} + \frac{\partial F}{\partial y} + \frac{\partial F}{\partial z} ) = ( \frac{\partial {F}^{vis}}{\partial x} + \frac{\partial {F}^{vis}}{\partial y} + \frac{\partial {F}^{vis}}{\partial z} ) \qquad ( 13 )$$

Compared to Equation (12), we can find that the face area vectors of control volume are equivalent to a transformer that converts the face fluxes into a derivative (differential form). The face area vectors play a key role for the finite volume method. The algebraic-volume meshfree method proposed a way to construct this kind of transformer for the discrete points.

Suppose that the computational domain is decomposed by points. For a point m, its point cloud set is \tilde{Ξ}(m). The total number of neighbours is Nₘ and Nₘ>d+1, where d is the number of dimensions. xₘ=(xₘ, yₘ, zₘ)^{T} represents the coordinate of point m. The midpoint of point m and its p-th neighbour n is given by

$${x}_{m , p} = \frac{1}{2} ( {x}_{m} + {x}_{n} ) \qquad ( 14 )$$

The Taylor series expansion of midpoint flux F_{m,p} at the point m is

F_{m,p}=Fₘ+∇Fₘ·(x_{m,p}−xₘ)+o(Δx)²,p∈\tilde{Ξ}(m) (15)

For a viscous flow simulation, the high aspect ratio point distribution is usually generated near the viscous wall. A weight ω is added to the both sides of equation to enhance the numerical accuracy in the solving of inverse matrix. Neglecting the high order part, we obtain the linear equations for all Nₘ neighbours

AₘBₘ=Cₘ (16)

with the abbreviations given by

$${A}_{m} = [ \begin{matrix}{ω}_{m , 1} ( {x}_{m , 1} - {x}_{m} ) & {ω}_{m , 1} ( {y}_{m , 1} - {y}_{m} ) & {ω}_{m , 1} ( {z}_{m , 1} - {z}_{m} ) & {ω}_{m , 1} \\ ⋮ & ⋮ & ⋮ & ⋮ \\ {ω}_{m , p} ( {x}_{m , p} - {x}_{m} ) & {ω}_{m , p} ( {y}_{m , p} - {y}_{m} ) & {ω}_{m , p} ( {z}_{m , p} - {z}_{m} ) & {ω}_{m , p} \\ ⋮ & ⋮ & ⋮ & ⋮ \\ {ω}_{m , {N}_{m}} ( {x}_{m , {N}_{m}} - {x}_{m} ) & {ω}_{m , {N}_{m}} ( {y}_{m , {N}_{m}} - {y}_{m} ) & {ω}_{m , {N}_{m}} ( {z}_{m , {N}_{m}} - {z}_{m} ) & {ω}_{m , {N}_{m}}\end{matrix} ] \qquad ( 17 )$$

$${B}_{m} = {[ \begin{matrix}\frac{\partial {F}_{m}}{\partial x} & \frac{\partial {F}_{m}}{\partial y} & \frac{\partial {F}_{m}}{\partial z} & {F}_{m}\end{matrix} ]}^{T} \qquad ( 18 )$$

$${C}_{m} = {[ \begin{matrix}{ω}_{m , 1} {F}_{m , 1} & … & {ω}_{m , p} {F}_{m , p} & … & {ω}_{m , {N}_{m}} {F}_{m , {N}_{m}}\end{matrix} ]}^{T} \qquad ( 19 )$$

The inverse of distance may be chosen as the weight a. The equation is solved by

Aₘ^{T}AₘBₘ=Aₘ^{T}Cₘ, (20)

It is the least squares solution of Equation (16). If matrix Aₘ^{T}Aₘ is singular, point m is moved to avoid the issue. Thus we obtain the solution

Bₘ=[(Aₘ^{T}Aₘ)⁻¹Aₘ^{T}]Cₘ (21)

Let Δ\tilde{S}_{m,p}ⁱ represent the p-th element of the i-th row of the matrix [(Δₘ^{T}Aₘ)⁻¹Aₘ^{T}], where superscript i stands for the i-th row of the vector. We obtain

Bₘⁱ=Σ_{p∈\tilde{Ξ}(m)}C_{m,p}Δ\tilde{S}_{m,p}ⁱ (22)

According to the relation (18), the first three elements of vector Bₘ are the derivatives of flux. Therefore, we obtain the derivatives of flux at point m

$$\{ \begin{matrix}\frac{\partial {F}_{m}}{\partial x} = {\sum }_{p ∈ \tilde{Ξ} ( m )} {ω}_{m , p} {F}_{m , p} Δ {\tilde{S}}_{m , p}^{1} \\ \frac{\partial {F}_{m}}{\partial y} = {\sum }_{p ∈ \tilde{Ξ} ( m )} {ω}_{m , p} {F}_{m , p} Δ {\tilde{S}}_{m , p}^{2} \\ \frac{\partial {F}_{m}}{\partial z} = {\sum }_{p ∈ \tilde{Ξ} ( m )} {ω}_{m , p} {F}_{m , p} Δ {\tilde{S}}_{m , p}^{3}\end{matrix} \qquad ( 23 )$$

Let

Δ\tilde{S}_{m,p}=ω_{m,p}[Δ\tilde{S}_{m,p}¹Δ\tilde{S}_{m,p}²Δ\tilde{S}_{m,p}³]^{T} (24)

We obtain the summation of derivatives of inviscid flux

$$\frac{\partial {F}_{m}}{\partial x} + \frac{\partial {F}_{m}}{\partial y} + \frac{\partial {F}_{m}}{\partial z} = {\sum }_{p ∈ \tilde{Ξ} ( m )} {F}_{m , p} \cdot Δ {\tilde{S}}_{m , p} \qquad ( 25 )$$

Compared to the finite volume discretization (Equation (12)), we call that the reconstructed vector Δ\tilde{S}_{m,p} is an algebraic area vector.

Similarly, we can get the summation of derivatives of viscous flux. Therefore, the discretization of differential form of NS Equation (13) by algebraic volume meshfree method is as follows

$$\frac{d ( {Q}_{m} {\tilde{V}}_{m} )}{dt} + {\sum }_{p ∈ \tilde{Ξ} ( m )} F ( {Q}_{m , p} ) \cdot Δ {\tilde{S}}_{m , p} = {\sum }_{p ∈ \tilde{Ξ} ( m )} {F}^{vis} ( {Q}_{m , p} ) \cdot Δ {\tilde{S}}_{m , p} \qquad ( 26 )$$

where \tilde{V}ₘ represents the “volume” of algebraic volume, here \tilde{V}ₘ=1.

On that basis, the sizes of algebraic volumes associated with each finite volume node and face area vectors between the respective algebraic volume and neighbouring volumes in the mesh are derived from solutions of discretized differential flux equations for each algebraic volume representing fluxes between the respective algebraic volume and each neighbouring volume in the mesh, for example the solution represented by Equation (20).

In this example, the discretized differential flux equations are Taylor series expansions of the fluxes at midpoints between fluxes between the respective algebraic volume and each neighbouring volume in the mesh. However, other forms of the discretized differential flux equations may be used.

In this example, therefore, defining a matrix Aₘ in respect of the m-th algebraic volume nodes by the following equation

$${A}_{m} = [ \begin{matrix}{ω}_{m , 1} ( {x}_{m , 1} - {x}_{m} ) & {ω}_{m , 1} ( {y}_{m , 1} - {y}_{m} ) & {ω}_{m , 1} ( {z}_{m , 1} - {z}_{m} ) & {ω}_{m , 1} \\ ⋮ & ⋮ & ⋮ & ⋮ \\ {ω}_{m , p} ( {x}_{m , p} - {x}_{m} ) & {ω}_{m , p} ( {y}_{m , p} - {y}_{m} ) & {ω}_{m , p} ( {z}_{m , p} - {z}_{m} ) & {ω}_{m , p} \\ ⋮ & ⋮ & ⋮ & ⋮ \\ {ω}_{m , {N}_{m}} ( {x}_{m , {N}_{m}} - {x}_{m} ) & {ω}_{m , {N}_{m}} ( {y}_{m , {N}_{m}} - {y}_{m} ) & {ω}_{m , {N}_{m}} ( {z}_{m , {N}_{m}} - {z}_{m} ) & {ω}_{m , {N}_{m}}\end{matrix} ]$$

where (xₘ, yₘ, zₘ) are the coordinates of the m-th algebraic volume node, (x_{m,p}, y_{m,p}, z_{m,p}) are the coordinates of the midpoint of the m-th algebraic volume nodes and its p-th neighbouring node, and ω_{m,p} is a weight, optionally taking a value of 1, in respect of the m-th algebraic volume node and its p-th neighbouring node, albeit that other forms of the matrix Aₘ could be used.

The step of deriving face area vectors comprises solving a matrix [(Aₘ^{T}Aₘ)⁻¹Aₘ^{T}] and deriving the face area vectors Δ\tilde{S}_{m,p} in respect of the m-th algebraic volume node and its p-th neighbouring nodes as

Δ\tilde{S}_{m,p}=ω_{m,p}[Δ\tilde{S}_{m,p}¹Δ\tilde{S}_{m,p}²Δ\tilde{S}_{m,p}³]^{T}

where Δ\tilde{S}_{m,p}ⁱ is the p-th element of the i-th row of the solved matrix [(Aₘ^{T}Aₘ)⁻¹Aₘ^{T}].

Weighting of the discretized differential flux equations may be used to enhance the numerical accuracy of the solutions, for example by incorporating the weights ω above, or indeed any other form or weight.

In the methods described above, the sizes \tilde{V}ₘ of the algebraic volumes are taken to be identical, that is unitary in the method above. More generally, this is not essential and the algebraic volumes may have varying sizes \tilde{V}ₘ. For example, the sizes \tilde{V}ₘ of the algebraic volumes may be proportional to the inverse of the local node density. When the sizes \tilde{V}ₘ of the algebraic volumes vary, they have predetermined values and the equations set out above are altered accordingly.

In step S5, an integral form of the modelling equations is discretised into the volume equations in respect of volumes associated with respective nodes of the mesh. As discussed above, the volume equations in respect of each volume representing the relationship between the size of the volume, the face area vectors between the respective volume and neighbouring volumes in the mesh, and fluxes across the face areas. The sizes and face area vectors in respect of the finite volume nodes derived in step S2 from the solutions of the geometrical equations are used in the volume equations for the finite volume nodes. The sizes and face area vectors in respect of the algebraic volume nodes derived in step S5 from the solutions of the discretized differential flux equations are used in the volume equations for the algebraic volume nodes.

As a result of the unified representation discussed above, there are no essential differences between the expression of finite volume method (Equation (12)) and expression of algebraic volume meshfree method (Equation (26)). Therefore, the discretization of NS equations can be expressed with a unified representation as follows:

$$\frac{d ( {Q}_{m} {\overline{V}}_{m} )}{dt} + {\sum }_{p ∈ \overline{Ξ} ( m )} F ( {Q}_{m , p} ) \cdot Δ {\overline{S}}_{m , p} = {\sum }_{p ∈ \overline{Ξ} ( m )} {F}^{vis} ( {Q}_{m , p} ) \cdot Δ {\overline{S}}_{m , p} \qquad ( 27 )$$

This is the general form of the volume equations that inherently covers both finite volumes and algebraic volumes.

In this general form, a set of points may be thought of as a special “mesh” of which the geometric characteristics of finite volume method is reconstructed by weighted least squares solution. The symbols are given by
1. Ξ̅(m) represents the set of contributors in calculation. It is the set Ξ(m) of neighbouring control volumes in finite volume method while that represents the point cloud set \tilde{Ξ}(m) in meshfree method, namely, the neighbouring algebraic volumes.
2. V̅ₘ denotes the general volume. It is the volume Vₘ of control volume calculated by the geometric formula in finite volume method while the size \tilde{V}ₘ of algebraic volume is constant in meshfree method.
3. S̅_{m,p} stands for the general face area vector. It is the geometric face area vector ΔS_{m,p} of control volume in finite volume method while the meshfree method calculates the algebraic area vector Δ\tilde{S}_{m,p} via the weighted least squares method.

Furthermore, it is found that all the geometry-related parameters Ξ̅(m), V̅ₘ, and S̅_{m,p} of mesh and point are the fundamental information calculated in pre-processor. The mesh-based information is obtained by geometric formula while meshfree point employs the weighted least squares reconstruction.

Although the solutions of the discretized differential flux equations are least squares solutions in this example, other solutions may alternatively be applied, for example using a least squares method, a radial basis function method, or finite difference method, etc.

Similarly, all the flow parameters (Qₘ, t, F(Q_{m,p}), and F^{vis}(Q_{m,p})) and numerical schemes of spatial and temporal discretization are the same for both mesh-based and meshfree methods. Thus most of the numerical code can be shared.

In step S7, the volume equations are solved to derive information on the physical properties of the physical system. In view of the unified representation, step S7 may uses a common solver for the algebraic volume nodes and the finite volume nodes. This ability to share most of the numerical code greatly simplifies the method compared to the use of meshfree methods. That is, step S7 may employ any of the numerical techniques known for structured and unstructured meshes, including any of those taught in the documents discussing structured and unstructured meshes that are acknowledged in the introduction.

Convective flux is now considered.

Because of the characteristics of convection, the discretization scheme of convective flux affects the stability significantly. It is evaluated by

F(Q_{m,p})·ΔS̅_{m,p}=F^{c}(Q_{m,p}^{L},Q_{m,p}^{R})·ΔS̅_{m,p} (28)

where Q_{m,p}^{L} and Q_{m,p}^{R} represent the values of left and right hand sides of the general face, respectively. F^{c} stands for the numerical discretization scheme for convective flux, such as central scheme with artificial dissipation (as disclosed in Reference [30]), flux-vector splitting (as disclosed in References [31, 32]), flux-difference splitting (as disclosed in Reference [33]), and so on.

It is only the first order if we directly take the flow solution of each volume. To achieve the second order precision, we have to reconstruct the left- and right-hand flow solution at the centre of general face. Assume that the solution is piecewise linearly distributed in each control/algebraic volume. For a flow variable, the values of left- and right-hand sides are extrapolated by

$$\{ \begin{matrix}{q}_{m , p}^{L} = {q}_{m} + {ϕ}_{m} [ ∇ {q}_{m} \cdot ( {x}_{m , p} - {x}_{m} ) ] \\ {q}_{m , p}^{R} = {q}_{n} + {ϕ}_{n} [ ∇ {q}_{n} \cdot ( {x}_{m , p} - {x}_{n} ) ]\end{matrix} \qquad ( 29 )$$

where x_{m,p} is the coordinate vector of face centre, xₘ stands for the coordinate vector of the centroid of control volume m, subscript n represents the p-th neighbour of control volume m, and 0 is the limiter function. Its value should tend to be 1 in the smooth region and 0 in the discontinuous region. Two popular limiters are adopted, that is the Barth & Jespersen limiter disclosed in Reference [34] and the Venkatakrishnan limiter disclosed in Reference [35]. ∇q stands for the gradient of variable q. It is obtained by Green-Gauss method and weighted least squares reconstruction as disclosed in Reference [36]. The former is solved by

$$∇ {q}_{m} = \frac{{\sum }_{p ∈ \overline{Ξ} ( m )} {q}_{m , p} Δ {\overline{S}}_{m , p}}{{\overline{V}}_{m}} \qquad ( 30 )$$

The viscous flux is solved by the central difference method.

A time marching method is applied in Step S7, as follows.

The semi-discrete form of NS Equations (27) can be written as follows:

$$\frac{d ( {Q}_{m} {\overline{V}}_{m} )}{dt} = - R ( {Q}_{m} ) \qquad ( 31 )$$

where R represents the residual of NS equations. Implicit discretization of the residual term of above equation yields:

$${\overline{V}}_{m} \frac{Δ {Q}_{m}^{k + 1}}{Δ t} = - R ( {Q}_{m}^{k + 1} ) \qquad ( 32 )$$

where k is the number of the time step, Δt is the size of the time step, and ΔQₘ^{k+1}=Qₘ^{k+1}−Qₘ^{k}.

Since the residual value at the next time step (k+1) cannot be obtained directly, the implicitly expressed residual term R is time linearized by

R(Qₘ^{k+1})≈R(Qₘ^{k})+Jₘ^{k}ΔQₘ^{k+1} (32)

where J stands for the Jacobian matrix, J=∂R/∂Q.

After flux splitting, we can obtain the algebraic equations which were solved by multiple symmetric Gauss-Seidel iterations. Each iteration is operated as a pair of sweep: one forward and one backward. More details of time-marching method are disclosed in Reference [39] and may be applied here.

In summary, therefore, the unified mesh/meshfree methods disclosed herein introduce a special control volume, i.e. the algebraic volume, to describe the discrete point. Both the control volume of finite volume method and algebraic volume of meshfree method contain neighbours, faces, and edges, etc. They can share the data structure of edge-based finite volume method in the framework of unified mesh/meshfree method. Furthermore, it is easy to find that there is no interface between mesh node and meshfree point when we use both simultaneously. Thus the unified mesh/meshfree method is as unified and compact as the unstructured one. This is attractive for the applications to solve the complicated configurations.

Indeed, the methods disclosed herein may be used to mesh arbitrarily complicated configurations. They naturally merge mesh and point together to solve the complicated configurations even with moving parts. Meshing failure is inherently avoided. The methods utilize a unified way to define mesh element which has geometric control volume and meshfree point which does not require the connection between nodes, as well as allowing a traditional finite volume solver to use the unified mesh/meshfree method with minor modification in pre-processor and boundary condition. The unified mesh/meshfree method is as flexible as meshfree method for meshing of complicated geometries, but the solution becomes more stable and accurate.

In particular, the methods disclosed herein are different from the idea of hybrid mesh methods, such as hybrid structured/unstructured mesh disclosed in References [28-32] and hybrid meshfree/mesh-based method disclosed in Reference [40-42]. These approaches require two different numerical methods (solvers) to deal with the relevant mesh type and special treatment for the interface of two types. This kind of hybrid methodology tremendously increases the difficulty and effort to develop and maintain the computational analysis code due to its large scale in general. The methods disclosed herein are unified and compact in both data structure and numerical method which are similar to those of vertex based finite volume method.

One example of a complicated configuration to which the methods disclosed herein may be applied is a double-wall effusion cooling system being investigated for use in the next generation of gas turbines. Such a system may include an inner wall and outer wall with pedestals which connect two walls. It is a multi-scale geometry that the scale of blade is about 100 times of the diameter of cooling holes. The large number of holes and pedestals is intractable as well. The junctions of hole, pedestal, and blade wall easily create singular points. Therefore, meshing of this kind of geometries is a great challenge by using the traditional mesh generation methods, but is soluble using the methods disclosed herein.

Some examples of methods disclosed herein applied to real physical systems are as follows.

The unified mesh/meshfree method is investigated by different mixing ideas of mesh nodes and meshfree points for meshing. A NACA (National Advisory Committee for Aeronautics) 0012 airfoil was employed to comprehensively verify the proposed method. Two typical flows, namely, low speed and transonic, are simulated. The flow conditions of low speed is Mach number 0.15, angle of attack is 0°, and Reynolds number is 6×10⁶. For the transonic flow, Mach number is 0.775, the angle of attack is 2.05°, and Reynolds number is 10′. The scheme disclosed in Reference [62] is adopted for the simulation of low speed flow while the solution disclosed in Reference [61] is employed for the transonic flow solution. The Venkatakrishnan limiter disclosed in Reference [64] is applied in the simulations.

The basic mesh was 225×65. The different unified meshes were generated by converting part of mesh nodes into meshfree points. Two types of mesh/meshfree unifying idea, namely, zonal meshing and fusion meshing, were utilized to obtain the unified mesh. The former includes mesh zone and point zone such that the same type of mesh can connect with each other well in its own zone. The interface of two zones were emphasized on the investigation. The latter converts a certain percentage of mesh nodes into meshfree points. The mesh nodes and meshfree points were sufficiently mixed. The interface appears everywhere in order to investigate the interface-free feature of general volume method. Each meshfree point cloud collects all the nodes which share the same mesh element with the current point.

The details of the unified mesh are shown in FIG. 5. The traditional mesh is shown in FIG. 5(a) and meshfree point is exhibited in FIG. 5(b). The latter is converted from the mesh node in order to keep consistent. For the zonal meshing demonstrated in FIGS. 5(c) and (d), the inner zone is defined by [x∈(−0.15, 1.15), y∈(−0.15, 0.15)]. There exists a clear interface between two zones. For the fusion meshing shown in FIG. 5(e) to 5(g), the mesh nodes and meshfree points are mixed with each other. The mesh nodes are converted into meshfree points through the number of node ID. For example, in the fusion meshing of 50% mesh nodes and 50% meshfree points shown in FIG. 5(e), the mesh nodes with odd ID remain mesh connection while those with even IDs are converted into meshfree points. Therefore, the mesh nodes and meshfree points are well mixed in fusion meshing.

Zonal unified meshing is considered as follows.

The interface can be shown clearly by employing two different mesh/point zones. So this section is to investigate the feature of solved flow across the interface. FIGS. 6 and 7 show the convergence history of maximum and average residual for the low speed and transonic flows, respectively. The residual is that of energy equation. In the figure, “FV” represents the traditional vertex-based finite volume method, “MF” stands for the algebraic volume meshfree method, “mesh & point” denotes that the inner zone is decomposed by mesh and outer is meshfree point, and “point & mesh” indicates that the inner zone is decomposed by meshfree point and outer is mesh. The flowfield is uniformly initialized by the farfield settings for all simulations. All methods converge well. The convergence history of general volume method based on both zonal unified meshes is quite close to each other and similar to that of the finite volume method and slightly better than that of meshfree method. The results indicate that the discontinuous shock wave does not affect the convergence of zonal unified mesh which exists at an interface between two types of mesh.

FIGS. 8 and 9 present the solved non-dimensional pressure of the low speed and transonic flows, respectively. The results obtained by two unified meshes look quite close and are very similar to those of finite volume and meshfree methods. Meanwhile, it is found that the pressure contour lines (depicted by black color) across the irregular interface (shown in red curve) between mesh zone and point zone are quite continuous. The close-up of shock wave and relevant meshes/points is exhibited in the right top box in FIG. 9. The shock wave is well solved across the interface of two zones. The comparison of surface pressure coefficient obtained by different methods is shown in FIG. 10. The results are in good agreement for the low speed flow. The mesh density is depicted as purple dots along the curve of meshfree method in FIG. 10(b). The results indicate that the shock wave is accurately captured in two nodes or points without any oscillation. The solutions obtained by unified mesh/meshfree method agrees well with experimental data. They are very close to those of finite volume method and slightly better than those of meshfree method.

Fusion unified meshing is considered as follows.

The zonal meshing treats the flow domain as two separate zone. The results indicate that the general volume method can successfully solve the interface between mesh zone and point zone without any oscillations. Therefore, the test cases go further in this section. The mesh nodes and meshfree points are sufficiently mixed together. The unified mesh is generated by the fusion of mesh and point. For example, in the critical fusion of 50% mixing depicted in FIG. 5 (e), the mesh and point are connected with each other everywhere. Each node is surrounded by meshfree points and each point is surrounded by nodes (shown in the close-up of FIG. 5(e)). This particular meshing idea is employed to comprehensively demonstrate the extreme situation of unified mesh/meshfree method and investigate the ability of general volume method which solves the mesh node and meshfree point without any interface treatment. It should be noted that the number of points is only a small proportion of unified mesh in most of applications such as FIGS. 5(f) and 5(g).

The comparison of convergence history is shown in FIGS. 11 and 12 for the low speed and transonic flows, respectively. Both the maximum and average residual of unified mesh/meshfree method converge well for all three cases. They perform quite similar convergence speed as traditional finite volume method. The convergence is slightly better than algebraic-volume meshfree method if only a small proportion of mesh nodes are converted into points. FIGS. 13 and 14 show the non-dimensional pressure contour. Each tiny red dot represent a meshfree point that is converted from a mesh node. All the solved flowfields look quite close to those of finite volume method shown in FIGS. 8 and 9. The contour lines (black) are quite continuous even for the discontinuous flow such as shock wave. The critical investigation fusion of 50% mixing impressively demonstrates the interface-free feature of unified mesh/meshfree method which naturally solve two types of mesh together via general volume method.

FIG. 15 compares the obtained surface pressure coefficient. The results of unified mesh/meshfree method agree well with those of experiment, finite volume method, and meshfree method. The result of 50% fusion meshing is close to that of meshfree method. It becomes closer to that of finite volume method when the proportion of points decreases. The results show quite good consistency. Moreover, it automatically solves the interface of mesh node/meshfree point. The obtained flow is accurate and oscillation is not observed.

Thus, the methods disclosed herein are well verified by a NACA0012 airfoil. Both subsonic and transonic high Reynolds number flows are utilized to investigate the capability. The unified mesh is generated through different mixing ways of mesh nodes and meshfree points. Some parts of nodes are converted into points. Both the zonal unified meshing and fusion unified meshing are utilized. The simulations show quite good convergence and accuracy. Moreover, the comparisons with finite volume and meshfree methods indicate that the unified mesh/meshfree method is comparable to the popular finite volume method on convergence and accuracy.

The potential to improve the convergence is considered as follows.

It is difficult to generate a mesh that each element can achieve the high mesh quality. The low-quality elements significantly affect the convergence and accuracy of simulations. Here is an example which utilizes the unified mesh/meshfree method (GM) to improve the convergence of simulation. The configuration of HIgh REynolds Number AeroStructural Dynamics (HIRENASD) Project is investigated. The sweptback angle of wing is 34°, and the BAC3-11 airfoil is utilized in any sections. The wing span is 1.28857m, reference length 0.3445m, and reference area 0.3926 m². The farfield of computational domain is one hundred times of reference length.

The mesh is shown in FIG. 16. Firstly, the traditional hybrid tetrahedral and prism mesh is generated. The total number of mesh elements is 8 million, and the number of mesh nodes 3 million. As shown in FIGS. 16(c) and 16(d), the mesh is refined at leading edge, trailing edge, and wing tip, etc. The results of this mesh solved by traditional finite volume (FV) method is compared to that of the unified mesh/meshfree method (GM) which converts the low quality elements into meshfree points (shown in FIG. 16(f)). The image indicates that the mesh quality is difficult to improve at the leading edge, trailing edge, wing/fuselage junction, and wing tip. It usually requires mesh refining in these regions to solve the complex geometry. Thus it becomes a challenge for the transition of volume mesh. This fact also indicates that the unified mesh/meshfree method has great potential in applications.

The comparison of convergence history is shown in FIG. 17. “Max” denotes the maximum residual of energy equation. “Av” represents the average one. “Cl” and “Cd” stand for the lift and drag coefficients, respectively. The freestream Mach number is 0.8 and reference length based Reynolds number is 7×10⁶. The angle of attack is 1.5°. The flow is uniformly initialized by freestream condition. SA turbulence model is utilized in simulation. At the beginning, the residual convergence history of both finite volume method (FV) and unified mesh/meshfree method (GM) is quite similar. Henceforth their difference becomes obvious. Both maximum and average residual of traditional finite volume (FV) method do not converge well due to the influence of low quality elements. On the contrary, those of unified mesh/meshfree method converge much better. From the FIG. 17(b), the convergence of aerodynamic force shows quite similar performance for both methods.

The flowfield solved by unified mesh/meshfree method (GM) is shown in FIG. 18. The pressure contour on the boundary is exhibited in FIG. 18(a) where “P” represents the non-dimensional pressure. The weak shock wave can be found on the top of supercritical wing. A slice of flowfield is shown in FIG. 18(b) where “Ma” stands for the Mach number. The shock wave can be found near the upper surface. The boundary layer is also clear. A close-up picture shown in the right top side of FIG. 18(b) compares the obtained shock wave with the scale of mesh cells. The width of shock is sharply captured within two cells. FIG. 19 shows the comparison of surface pressure coefficient on different spanwise stations of wing. The results obtained by finite volume method (FV) and unified mesh/meshfree method (GM) are in quite good agreement. They almost coincide on all the spanwise stations (such that it is in fact difficult to see the FV curves in the drawings). The comparisons indicate that the unified mesh/meshfree method (GM) converted the low quality elements into meshfree points improves the convergence of simulation significantly.

A double-wall effusion cooling configuration is considered as follows.

A higher turbine entry temperature can obtain better thermodynamic efficiency. Nowadays it is well in excess of the melting temperature of the turbine blade materials. A good cooling technology can not only maintain the blade but also prolong the lifetime of turbine components. The double-wall effusion cooling method can effectively improve the cooling performance on high pressure turbine of gas turbine. But its configuration is complicated for CFD simulations. One of the challenges is the meshing of this multi-scale geometry. It is difficult to generate a proper mesh of which the total number is not too large and the quality is not too low to simulate the flow. It usually requires much manual intervention and takes long time if the traditional unstructured mesh is utilized. The unified mesh/meshfree method is employed to challenge this complicated application.

The unified mesh/meshfree method for a double-wall effusion cooling configuration is shown in FIG. 20. The computational domain and boundary conditions are described in FIG. 20(a). The total pressure and total temperature are used for inlet boundary while static pressure is adopted for the outlet. The coolant is fed at the bottom. It includes 2×5 repeating units which is depicted in FIG. 20(b). The size of repeating unit is 4.8 mm×4.8 mm. It contains 4 impingement holes, 9 pedestals, and 1 film hole. The inclination angle of impingement holes and pedestals is 900 while that of film hole is 30°. The diameter of impingement holes and film holes is 0.4 mm while the pedestals are the size of 0.4 mm×0.4 mm. The height of impingement holes and pedestals is 0.8 mm and the thickness of inner and outer walls is also 0.8 mm.

The domain is firstly meshed by tetrahedron of which the details are demonstrated in FIG. 20(c) to 20(g). It can be found that the mesh nodes is well distributed. The mesh is refined around the holes and pedestals. There are singular points at the junctions of impingement holes and pedestals, and junction of pedestal and film hole. After the prismatic boundary layer meshing exhibited in FIGS. 20(i) and 20(j), there exists a number of negative-volume elements. For the traditional unstructured mesh methods, it needs to repeatedly adjust the meshing parameters or modify the geometry until these troublesome elements do not appear. On the contrary, for unified mesh/meshfree method, the processor of mesh quality assessment converts the nodes of those elements into meshfree points, as an example shown in FIGS. 20(k) and 20(l). Moreover, the unified mesh generation is automated and speedy. It only takes one day to generate the mesh. The total number of unified mesh elements including mesh nodes and meshfree points is 19 million.

The Mach number of hot mainstream flow is 0.7, pressure is 70 bar, and temperature is 2300K. The temperature ratio of mainstream/coolant is 2.5. The convergence history of simulation is shown in FIG. 21. The flow is uniformly initialized by the mainstream inlet condition. k−ω SST turbulence model is employed. The blowing ratio (M) defined by ρ_{c}u_{c}/βₘuₘ is 1. Here subscript c stands for coolant while m represents mainstream. The simulation converges well. FIG. 22 demonstrates the streamlines going from plenum to mainstream. The colour along the lines represents the turbulence kinetic energy. It shows the complex path of coolant which goes through impingement holes, then travels around the pedestals and ejects via the film holes, finally mixes with the mainstream hot gas.

The influence of blowing ratio (M) is investigated in FIGS. 23 and 24. The slice shown in the side view of FIG. 23(a) is a slice at the centreline of film holes and normal to the wall. The wall temperature is displayed on the top view. Different slices downstream of each film hole are demonstrated in FIG. 23(b) where “D” represent the diameter of film hole. The temperature scale is only shown at the bottom of FIG. 23(a). The blowing ratio significantly affects the temperature field. Lower blowing ratio represents less coolant ejection. From blowing ratio 0.2 to 0.5, the film becomes better due to the attached cooling flow. The surface obtains a stronger protection. When the blowing ratio is further increased to 0.7, it is not easy to tell the difference from blowing ratio 0.5. On the contrary, the film coverage becomes worse when the blowing ratio is increased to 1. The lift-off coolant is clearly demonstrated. Meanwhile, the films upstream also affect those downstream significantly. The film becomes better and better at low blowing ratio but it becomes worse at high blowing ratio as the flow passes the film holes.

FIG. 24(a) compares the iso-surface of temperature 1250K on both side view and top view. The iso-surface disappears quickly at low blowing ratio. The high coolant mass flow rate enhances the cooling effect. Meanwhile, it becomes stronger and stronger downstream. The adiabatic film effectiveness (η) defined by (T₀−T_{w})/(T₀−T_{c}) is shown in FIG. 24(b). T₀ represents the total temperature of mainstream, T_{w} stands for the local wall temperature, and T₀ denotes the temperature of coolant. η=0 represents no cooling effect and η=1 means the wall obtains the best cooling. The increase of blowing ratio can improve the film effectiveness when the blowing ratio is lower than 0.5. However, the film effectiveness decreases when the blowing ratio increases further.

### REFERENCES

[1] F. Wang, L. di Mare, Mesh generation for turbomachinery blade passages with three-dimensional endwall features, Journal of Propulsion 889 and Power 33 (2017) 1459-1472.
[2] L. Xu, P. Weng, High order accurate and low dissipation method for unsteady compressible viscous flow computation on helicopter rotor in forward flight, Journal of Computational Physics 258 (2014) 470-488.
[3] P. Eiseman, K. Rajagopalan, Automatic topology generation, in: Notes on Numerical Fluid Mechanics and Multidisciplinary Design (NNFM), volume 90, Springer-Verlag, 2005, pp. 112-124.
[4] D. J. Mavriplis, Unstructured grid techniques, Annual Review of Fluid Mechanics, Vol. 29 (1997): 473-514.
[5] S. Z. Pirzadeh, Advanced unstructured grid generation for complex aerodynamic applications, AIAA Journal, Vol. 48 (2010): 904-915.
[6] Y. Zheng, Z. Xiao, J. Chen, J. Zhang, Novel methodology for viscous layer meshing by the boundary element method, AIAA Journal, Vol. 56 (2018): 209-221.
[7] M. Harada, Y. Tamaki, Y. Takahashi, T. Imamura, Simple and robust cut-cell method for high-Reynolds-number-flow simulation on Cartesian grids, AIAA Journal, Vol. 55 (2017): 2833-2841.
[8] Y. Ito, A. Shih, R. Koomullil, N. Kasmai, M. Jankun-Kelly, D. Thompson, Solution adaptive mesh generation using feature-aligned embedded surface meshes, AIAA Journal, Vol. 47 (2009): 1879-1888.
[9] Y. Zheng, M. S. Liou, A novel approach of three-dimensional hybrid grid methodology: Part 1. grid generation, Computer Methods in Applied Mechanics and Engineering, Vol. 192 (2003): 4147-4171.
[10] M. S. Liou, Y. Zheng, A novel approach of three-dimensional hybrid grid methodology: Part 2. flow solution, Computer Methods in Applied Mechanics and Engineering, Vol. 192 (2003): 4173-4193.
[11] D. Howe, Hybrid CART3D/OVERFLOW near-field analysis of a low boom configuration with wind tunnel comparisons (invited), in: 29th AIAA Applied Aerodynamics Conference, American Institute of Aeronautics and Astronautics, 2011.
[12] E. Onate, C. Sacco, S. Idelsohn, A finite point method for incompressible flow problems, Computing and Visualization in Science, Vol. 3 (2000): 67-75.
[13] G. Harish, M. Pavanakumar, K. Anandhanarayanan, Store separation dynamics using grid-free Euler solver, in: 24th AIAA Applied Aerodynamics Conference, American Institute of Aeronautics and Astronautics, 2006.
[14] D. J. Kennett, S. Timme, J. Angulo, K. J. Badcock, An implicit meshless method for application in computational fluid dynamics, International Journal for Numerical Methods in Fluids, Vol. 71 (2012): 1007-1028.
[15] R. Zamolo, E. Nobile, B. Sarler, Novel multilevel techniques for convergence acceleration in the solution of systems of equations arising from RBF-FD meshless discretizations, Journal of Computational Physics, Vol. 392 (2019): 311-334.
[16] T. P. Fries, H. G. Matthies, A stabilized and coupled meshfree/meshbased method for the incompressible Navier-Stokes equations-part I: Stabilization, Computer Methods in Applied Mechanics and Engineering, Vol. 195 (2006): 6205-6224.
[17] T. P. Fries, H. G. Matthies, A stabilized and coupled mesh-free/meshbased method for the incompressible Navier-Stokes equations-part II: Coupling, Computer Methods in Applied Mechanics and Engineering, Vol. 195 (2006): 6191-6204.
[18] G. Wang, Z. Ye, C. Li, C. Jiang, A unified gridless/FVM solution method for simulating high reynolds number viscous flow, Proceedings of ICCES'07 (2007): 519-528.
[19] P. Spalart, S. Allmaras, A one-equation turbulence model for aerodynamic flows, in: 30th Aerospace Sciences Meeting and Exhibit, American Institute of Aeronautics and Astronautics, 1992.
[20] F. R. Menter, Two-equation eddy-viscosity turbulence models for engineering applications, AIAA Journal 32 (1994) 1598-1605.
[21] S. Pirzadeh, Three-dimensional unstructured viscous grids by the advancing-layers method, AIAA Journal 34 (1996) 43-49.
[22] Y. Ito, K. Nakahashi, Improvements in the reliability and quality of un-structured hybrid mesh generation, International Journal for Numerical Methods in Fluids, Vol. 45 (2004): 79-108.
[23] S. L. Karman, Unstructured viscous layer insertion using linear-elastic smoothing, AIAA Journal, 45 (2007): 168-180.
[24] T. Rendall, C. Allen, Efficient mesh motion using radial basis functions with data reduction algorithms, Journal of Computational Physics, Vol. 228 (2009): 6231-6249.
[25] G. Wang, H. H. Mian, Z. Ye, J. Lee, Improved point selection method for hybrid-unstructured mesh deformation using radial basis functions, AIAA Journal 53 (2015) 1016-1025.
[26] L. Kedward, C. Allen, T. Rendall, Efficient and exact mesh deformation using multiscale RBF interpolation, Journal of Computational Physics 345 (2017) 732-751.
[27] G. Wang, X. Chen, Z. Liu, Mesh deformation on 3D complex configurations using multistep radial basis functions interpolation, Chinese Journal of Aeronautics 31 (2018) 660-671.
[28] Knupp P. M. Algebraic Mesh Quality Metrics, SIAM Journal on Scientific Computing, Vol. 23 (2001): 193-218.
[29] Y. Jiang, Algebraic-volume meshfree method for application in finite volume solver, Computer Methods in Applied Mechanics and Engineer, Vol. 355 (2009): 44-66.
[30] A. Jameson, W. Schmidt, E. Turkel, Numerical solution of the Euler equations by finite volume methods using Runge Kutta time stepping schemes, in: 14th Fluid and Plasma Dynamics Conference, American Institute of Aeronautics and Astronautics, 1981.
[31] B. van Leer, Towards the ultimate conservative difference scheme. V. a second-order sequel to Godunovs method, Journal of Computational Physics 32 (1979) 101-136.
[32] M. S. Liou, A sequel to AUSM: AUSM+, Journal of Computational Physics 129 (1996) 364-382.
[33] P. L. Roe, Characteristic-based schemes for the Euler equations, Annual Review of Fluid Mechanics 18 (1986) 337-365.
[34] T. Barth, D. Jespersen, The design and application of upwind schemes on unstructured meshes, in: 27th Aerospace Sciences Meeting, American Institute of Aeronautics and Astronautics, 1989.
[35] V. Venkatakrishnan, Convergence to steady state solutions of the Euler equations on unstructured grids with limiters, Journal of Computational Physics 118 (1995) 120-130.
[36] D. Mavriplis, Revisiting the least-squares procedure for gradient reconstruction on unstructured meshes, in: 16th AIAA Computational Fluid Dynamics Conference, American Institute of Aeronautics and Astronautics, 2003.

1. A method of computational analysis of a physical system that is modelled by modelling equations representing relationships between physical properties of the physical system, the method comprising:
generating a mesh of discrete nodes;
in respect of at least some of the nodes referred to as algebraic volume nodes, deriving face area vectors between algebraic volumes associated with each algebraic volume node and neighbouring volumes in the mesh from solutions of discretized differential flux equations for each algebraic volume representing fluxes between the respective algebraic volume and each neighbouring volume in the mesh;
discretizing an integral form of the modelling equations into volume equations in respect of volumes associated with respective nodes of the mesh, the volume equations in respect of each volume representing the relationship between the size of the volume, the face area vectors between the respective volume and neighbouring volumes in the mesh, and fluxes across the face areas,
wherein the face area vectors represented in the volume equations in respect of the algebraic volume nodes are the face area vectors derived from the solutions of the discretized differential flux equations; and
solving the volume equations and deriving information on the physical properties of the physical system.

2. A method according to claim 1, wherein the solutions of discretized differential flux equations are least squares solutions.

3. A method according to claim 1, wherein the discretized differential flux equations are weighted to enhance the numerical accuracy of the solutions.

4. A method according to claim 1, wherein the sizes of the algebraic volumes are identical.

5. A method according to claim 1, wherein the discretized differential flux equations are Taylor series expansions of the fluxes at midpoints between fluxes between the respective algebraic volume and each neighbouring volume in the mesh.

6. A method according to claim 1, wherein
defining a matrix Aₘ in respect of the m-th algebraic volume nodes by the following equation
$${A}_{m} = [ \begin{matrix}{ω}_{m , 1} ( {x}_{m , 1} - {x}_{m} ) & {ω}_{m , 1} ( {y}_{m , 1} - {y}_{m} ) & {ω}_{m , 1} ( {z}_{m , 1} - {z}_{m} ) & {ω}_{m , 1} \\ ⋮ & ⋮ & ⋮ & ⋮ \\ {ω}_{m , p} ( {x}_{m , p} - {x}_{m} ) & {ω}_{m , p} ( {y}_{m , p} - {y}_{m} ) & {ω}_{m , p} ( {z}_{m , p} - {z}_{m} ) & {ω}_{m , p} \\ ⋮ & ⋮ & ⋮ & ⋮ \\ {ω}_{m , {N}_{m}} ( {x}_{m , {N}_{m}} - {x}_{m} ) & {ω}_{m , {N}_{m}} ( {y}_{m , {N}_{m}} - {y}_{m} ) & {ω}_{m , {N}_{m}} ( {z}_{m , {N}_{m}} - {z}_{m} ) & {ω}_{m , {N}_{m}}\end{matrix} ]$$
where (xₘ, yₘ, zₘ) are the coordinates of the m-th algebraic volume node, (x_{m,p}, y_{m,p}, z_{m,p}) are the coordinates of the midpoint of the m-th algebraic volume nodes and its p-th neighbouring node, and ω_{m,p} is a weight, optionally taking a value of 1, in respect of the m-th algebraic volume node and its p-th neighbouring node,
the step of deriving face area vectors comprises solving a matrix [(Aₘ^{T}Aₘ)⁻¹Aₘ^{T}] and deriving the face area vectors Δ\tilde{S}_{m,p} in respect of the m-th algebraic volume node and its p-th neighbouring nodes as
Δ\tilde{S}_{m,p}=ω_{m,p}[Δ\tilde{S}_{m,p}¹Δ\tilde{S}_{m,p}²Δ\tilde{S}_{m,p}³]^{T}
where Δ\tilde{S}_{m,p}ⁱ is the p-th element of the i-th row of the solved matrix [(Aₘ^{T}Aₘ)⁻¹Aₘ^{T}].

7. A method according to claim 1, wherein the physical system is a fluid system.

8. A method according to claim 7, wherein the modelling equations are the Navier-Stokes equations, optionally including modifications for inviscid flow.

9. A method according to claim 1, wherein the physical system has physical property that is conserved.

10. A method according to claim 1, further comprising, in respect of nodes other than the algebraic volume nodes and referred to as finite volume nodes, deriving sizes of finite volumes associated with each finite volume node and face area vectors between the respective finite volume and neighbouring volumes in the mesh from solutions of geometrical equations representing the geometry of the finite volumes,
wherein the sizes and face area vectors represented in the volume equations in respect of the finite volume nodes are the sizes and face area vectors derived from the solutions of the geometrical equations.

11. A method according to claim 10, further comprising selecting the at least some of the nodes as algebraic volume nodes and other nodes as finite volume nodes.

12. A method according to claim 11, wherein
the method further comprises deriving at least one measure of quality of a finite volume associated with each node; and
the step of selecting the at least some of the nodes comprises selecting nodes that are indicated by the at least one measure of quality to be of low quality as algebraic volume nodes and other nodes as finite volume nodes.

13. A method according to claim 12, wherein the at least one measure of quality includes one or more of
the size of the finite volume;
a measure of aspect ratio of the finite volume;
a measure of skewness of the mesh in the locality of the node;
a measure of smoothness of transitions in the size of finite volumes associated with neighbouring nodes in the locality of the node; and
an orthogonal quality of the finite volume.

14. A method according to claim 10, wherein the volume equations in respect of the algebraic volume nodes and the volume equations in respect of the finite volume nodes have a unified representation.

15. A method according to claim 14, wherein the step of solving the volume equations uses a common solver for the algebraic volume nodes and the finite volume nodes.

16. A computer program capable of execution by a computer apparatus and configured, on execution, to cause the computer apparatus to perform a method according to claim 1.

17. A computer-readable storage medium storing a computer program according to claim 16.

18. A computer apparatus arranged to perform a method according to 1.
